(19) United States
(12) Patent Application Publication
(10) Pub. No.: US 2005/0004958 A1
(43) Pub. Date: Jan. 6, 2005

(54) Single instruction multiple data implementation of finite impulse response filters including adjustment of result

(75) Inventors: Scott Contini, San Diego, CA (US); Chanchal Chatterjee, San Diego, CA (US)

Correspondence Address: CARPENTER & KULAS, LLP, 1900 EMBARCADERO ROAD, SUITE 109, PALO ALTO, CA, 94303, US

(73) Assignee: General Instrument Corporation, Horsham, PA (US)

(21) Appl. No.: 10/613,927

(22) Filed: Jul. 5, 2003

(51) Int. Cl. G06F 15/00

(52) U.S. Cl. 708/200

(57) ABSTRACT

A system for adjusting the result of a derivation of finite impulse response (FIR) values. A single-instruction multiple data (SIMD) type of operation is used. In a preferred embodiment, the operation is achieved by an instruction called PAVG. The results of PAVG are a rounded-up average of two sets of packed values. Adjustments are made on the rounded-up average to obtain an exact desired result for various filter calculations. The invention also provides approaches to achieving approximate desired results that differ from the exact desired results yet remain within acceptable error ranges. The approximate approaches require less computation and can be advantageous in different applications, or embodiments, of the invention. An adjusted approximate approach improves the accuracy of the approximate approach. Various techniques for minimizing processor resources (e.g., processing cycles, memory) are presented.

### CROSS-REFERENCES TO RELATED APPLICATIONS

This application is related to the following co-pending U.S. patent applications which are hereby incorporated by reference as if set forth in full in this specification:
Ser. No. ______, filed on ______, entitled “SINGLE INSTRUCTION MULTIPLE DATA IMPLEMENTATIONS OF FINITE IMPULSE RESPONSE FILTERS”; and
Ser. No. 10/057,694, filed on Jan. 23, 2002, entitled “METHODS FOR EFFICIENT FILTERING OF DIGITAL SIGNALS.”

### COPYRIGHT NOTICE

Portions of the disclosure recited in this specification contain material that is subject to copyright protection. Specifically, source code instructions by which specific embodiments of the present invention are practiced in a computer system are included. The copyright owner has no objection to the facsimile reproduction of the specification as filed in the Patent and Trademark Office. Otherwise all copyright rights are reserved.

### BACKGROUND OF THE INVENTION

1. Field of the Invention

This invention is related in general to computer processing and more specifically to the use of single instruction multiple data (SIMD) instructions to achieve finite impulse response filter operations in a digital processor.

2. Description of the Background Art

Finite Impulse Response (FIR) filter operations are an important type of digital computation or processing. FIR filters are commonly used, for example, in pre-processing, post-processing, motion compensation, and motion estimation for video compression standards. The implementation of FIR filters in computer programs, or other digital processing approaches, is useful in many other applications including audio processing, signal conditioning, simulation of electronic components, etc.

FIR filter operations can be very demanding on digital processing systems because of the large number of iterative operations that must be performed very quickly. The number of operations, speed of operation, resolution of coefficient values, and other factors all contribute to the accuracy of the implementation and the amount of processing resources that are necessary to achieve a design goal. In this respect, a slight advantage in FIR filter operations that are executed frequently (i.e., in an “inner loop” of a program) can result in very significant performance gains.

An FIR filter that is of special interest in video compression and encoding techniques is referred to as a transversal or tapped delay filter. These filters multiply a set of coefficients to pixel values of a video frame to generate a new pixel value. Such an operation is useful, for example, to compress an image by combining adjacent pixel values into a smaller number of pixel values. Typically, this type of FIR filter includes only positive coefficients.

FIG. 1 illustrates four pixel values a₁, a₂, a₃, and a₄. Subpixel b is desired to be the average of the four pixels computed as:
b=(a₁+a₂+a₃+a₄+2)>>2, (1)
where >> is a bitwise right shift operator.

In a typical application where pixel values are limited to values in the range 0-255, the pixels a₁, . . . ,a₄ are each represented in one byte or 8 bits. Thus, a total of four bytes is necessary to operate on the four pixel values at once.

Typically, a single frame in a digital video presentation of moderate resolution can include 600×800=480,000 pixels. Such a frame might be displayed 30 times per second. Moreover, it may be necessary to perform additional “passes” over the frame so that, for example, in subsequent passes the pixels, themselves, are combined into subpixels to further compress an image. Thus, numerous subpixel computations may be necessary. Further digital video formats, such as high-definition television, use much higher screen resolutions and color depths. It should be apparent that such filter operations could place enormous requirements on processing resources, especially when the operations must be performed in real time.

One approach that the prior art uses to provide increased efficiency in filter or array operations is to use Single Instruction Multiple Data (SIMD) instructions. Such instructions allow value-packing, byte-packing, or other concatenating of values into a single word or other unit of data. The unit of data can be processed quickly by performing a desired operation in parallel on the packed values.

SIMD-type instructions are available in many processors. Examples include Intel Multi-Media Extensions (MMX)™ and Streaming SIMD Extension (SSE)™, as well as NEC VR5432, Equator MAP-CA™, and Philips TM-1300 processors. In processors whose architecture supports SIMD instructions there are typically multiple identical processors, N, each with its own local memory where it can store data. All processors work under the control of a single instruction stream issued by a central control unit. There are typically N data streams, one per processor. The processors operate synchronously: at each step, all processors execute the same instruction on a different data element. This architecture allows N computations in parallel. Thus, if N=8, it is possible to achieve a computational speedup of 8.

FIG. 2 provides an example of the operation of a SIMD instruction. The SIMD instruction performs an operation, “OP,” on two sets of data: A=[a₁, . . . ,a₈], a vector of 8 data values, each of which is an unsigned 8-bit integer, i.e., aᵢ∈[0,255]; and B=[b₁, . . . ,b₈], another vector of unsigned integers within the range [0,255]. The final result C=[c₁, . . . ,c₈] is achieved by simultaneously operating on all 8 values of aᵢ and bᵢ as cᵢ=aᵢ OP bᵢ, for i=1, . . . ,8. In this example, A, B and C are 64-bit registers in which all 8 values of aᵢ, bᵢ, and cᵢ are packed as contiguous bytes as shown in FIG. 2, i.e., N=8. Such operations are also known as packed operations, since 8 values of data are packed in a single register A, B or C.

One specific type of operation of interest in filter operations is the PAVG operation that can be found, e.g., in the Intel MMX™ instruction set. The PAVG instruction performs the following computation:
PAVG(A,B)=[(aᵢ+bᵢ+1)>>1, i=1, . . . ,8]. (2)

This operation takes 8-bit values of aᵢ, bᵢ, and stores the intermediate sum (aᵢ+bᵢ+1) in 9 bits before doing bitwise logical right shift operation to get the final result. It is available in many processors, including the ones mentioned above, and uses only one instruction. This instruction has the latency of 1 clock cycle in the Intel Pentium III, 2 clock cycles in Intel Pentium 4, and Advanced Micro Device's (AMD's) Athlon, with a throughput of 1 clock cycle. The same performance is realized for other operations in these architectures, such as packed addition (+), subtraction (−), bitwise AND (&), bitwise OR (|), bitwise EXCLUSIVE-OR (\hat{ }), bitwise right shift (>>), and bitwise left shift (<<) operations.

Although SIMD instructions can improve the efficiency and speed of computations, such instructions are sometimes difficult to use effectively when the SIMD instructions do not provide the exact type of operation needed. For example, as stated above, PAVG computes (aᵢ+bᵢ+1)>>1. An average of two vectors rounded up. However, it is more desirable in some filter operations to obtain (aᵢ+bᵢ)>>1, which is a truncated average where the remainder, or fractional part, is discarded. Such a difference in operation is significant where multiple passes of frame data are made as the average intensity value of subpixels may increase and result in artifacts or other objectionable qualities to the processed data. In the architectures discussed herein, a SIMD instruction to compute (aᵢ+bᵢ)>>1 is not provided. Typically, a non-SIMD approach must be used.

A problem also arises when the number of arguments required by a SIMD operation is not the same as the number of variables in a formula to be implemented by the SIMD operation. For example, if a SIMD instruction accepts two arguments then it is “mismatched” to implement a formula, computation or operation with more than two variables or values. The same can be said, for example, for a SIMD instruction with three arguments used to implement a formula with other than three variables, etc.

FIG. 3 illustrates a non-SIMD approach to compute (aᵢ+bᵢ)>>1.

In FIG. 3, aᵢ, bᵢ are unsigned integers within the range [0,255], i.e., each aᵢ, bᵢ is represented in 8 bits. The number of processors, N=8, i.e., the operation (aᵢ+bᵢ)>>1 is simultaneously performed on 8 values of aᵢ and bᵢ for i=1, . . . ,8. All 8 values of aᵢ (usually contiguous pixels) are packed in 64-bit register, A, and 8 values of bᵢ in 64-bit register B. Since aᵢ+bᵢ can exceed 8 bits, the 8-bit (byte) values of aᵢ, bᵢ are unpacked into 16-bits (words) as four 16-bit values per 64-bit register. Then the packed registers A and B are added together, followed by bitwise logical right shift by 1, followed by packing again. Note that in most processors, data can be packed into 64-bit registers as 8 (byte), 16 (word), 32 (dword), or 64 (qword) bit values only. FIG. 3 shows the conventional method of doing the packed operation cᵢ=(aᵢ+bᵢ)>>1 for i=1, . . . ,8. It is clear from FIG. 3, that given sufficient memory, 9 instructions are needed to achieve the result cᵢ=(aᵢ+bᵢ)>>1 for all 8 values of aᵢ and bᵢ. Each instruction in FIG. 3 is represented by an ellipse.

### SUMMARY OF EMBODIMENTS OF THE INVENTION

The invention provides improved results in some cases of digital calculation of finite impulse response (FIR) filters. A preferred embodiment of the invention is applied to techniques for FIR calculation discussed in the co-pending patent application entitled “SINGLE INSTRUCTION MULTIPLE DATA IMPLEMENTATIONS OF FINITE IMPULSE RESPONSE FILTERS,” referenced, above. In the co-pending patent application a system for efficient derivation of FIR values is presented using single-instruction multiple data (SIMD) types of operations. In a preferred embodiment, the results of the FIR calculations are subjected to additional operations using a SIMD instruction called PAVG. The results of PAVG are a rounded-up average of two sets of packed values. Adjustments are made on the rounded-up average to obtain an exact desired result for various filter calculations, or to obtain results within a desired error range, or results that do not exceed, or fall below, desired values in relation to the exact answer. Various techniques for minimizing processor resources (e.g., processing cycles, memory) are presented.

These provisions together with the various ancillary provisions and features which will become apparent to those artisans possessing skill in the art as the following description proceeds are attained by devices, assemblies, systems and methods of embodiments of the present invention, various embodiments thereof being shown with reference to the accompanying drawings, by way of example only, wherein:

One embodiment of the invention provides [@@]

### BRIEF DESCRIPTION OF THE DRAWINGS

FIG. 1 illustrates a subpixel average of four pixel values;

FIG. 2 shows an example of the execution of a single-instruction multiple-data (SIMD) instruction;

FIG. 3 shows a non-SIMD approach to a calculation; and

FIG. 4 shows a SIMD implementation with adjustment.

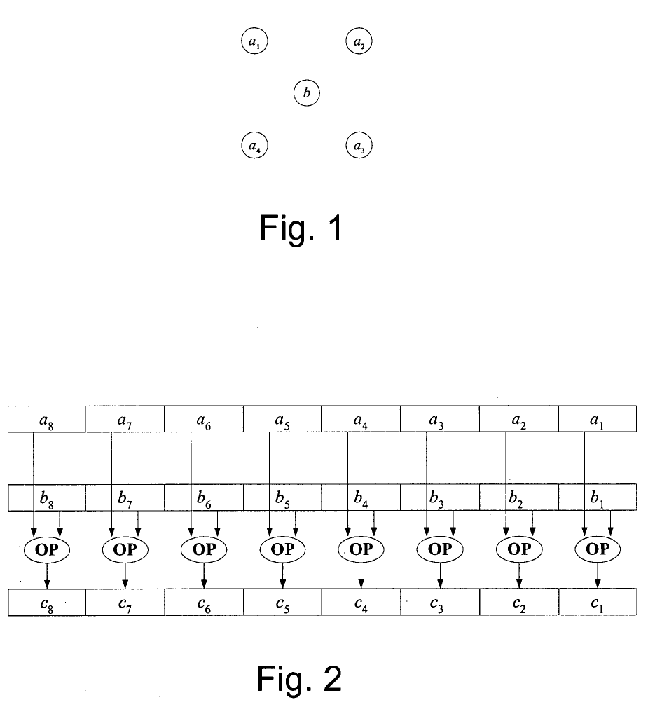

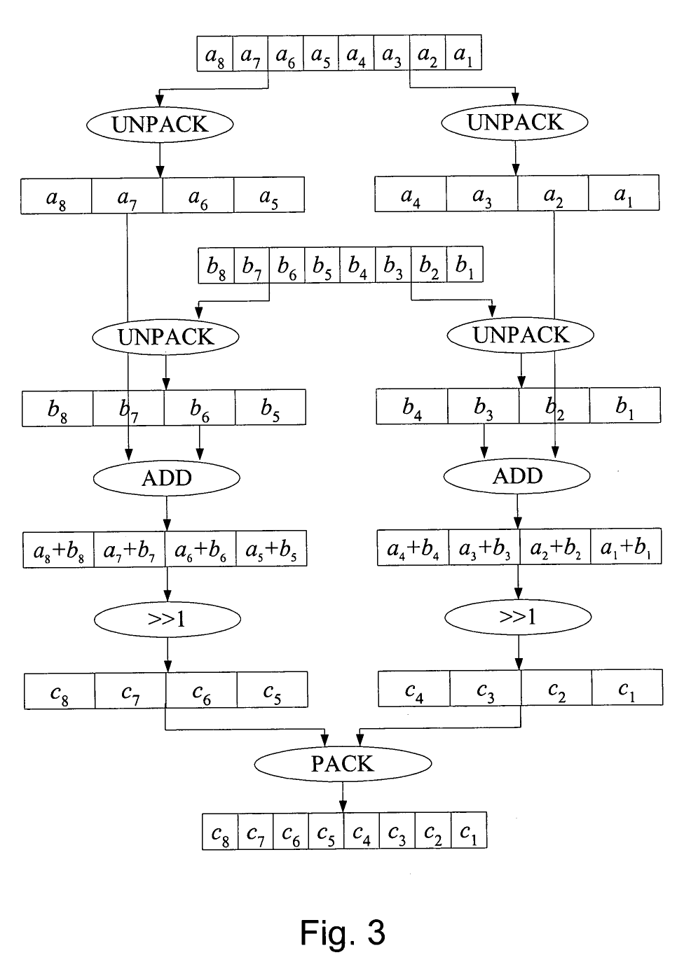

### DETAILED DESCRIPTION OF EMBODIMENTS OF THE INVENTION

The technique of the present invention includes adjusting an FIR calculation result using SIMD instructions to obtain an improved result. This technique is the focus of section 5 of this specification. Other sections include text from the co-pending patent application entitled “SINGLE INSTRUCTION MULTIPLE DATA IMPLEMENTATIONS OF FINITE IMPULSE RESPONSE FILTERS,” cited, above, upon whose results the adjustments of the present invention are based.

A preferred embodiment of the invention uses Intel's MMX/SSE architecture, including the SIMD PAVG operation. Other embodiments may use other processors, instructions and operations in a manner similar to that disclosed herein and realize similar computational benefits. In addition, other techniques and approaches for performing processing may benefit from one or more of the features presented herein, such as the techniques of the related patent application “METHODS FOR EFFICIENT FILTERING OF DIGITAL SIGNALS,” cited above.

Table I shows notations used in this application.

TABLE I

| Operator | Description |
|---|---|
| + | Addition |
| − | subtraction |
| & | bitwise AND |
| \| | bitwise OR |
| \hat{ } | bitwise exclusive OR |
| >> | bitwise logical right shift |
| << | bitwise logical left shift |
| ˜ | Bitwise NOT |
| CLIP(x) | Clips x to range [0,255] |
| ODD(x) | Returns 1 when x is odd, 0 otherwise |
| EVEN(x) | Returns 1 when x is even, 0 otherwise |

The present invention allows computing cᵢ=(aᵢ+bᵢ)>>1 for i=1, . . . ,8, in an efficient manner using a SIMD instruction such as PAVG. Note that simply using the PAVG instruction on packed values in registers A and B will not yield the correct answer. For example, when aᵢ+bᵢ is an odd number PAVG(aᵢ, bᵢ) gives a result that is one more than the correct answer. The result of a PAVG operation must be adjusted as follows:
C=PAVG(A, B)−(A\hat{ }B) & 0x01,
where 0x01 is a 8-bit number whose least significant bit is 1 and the rest are 0's.

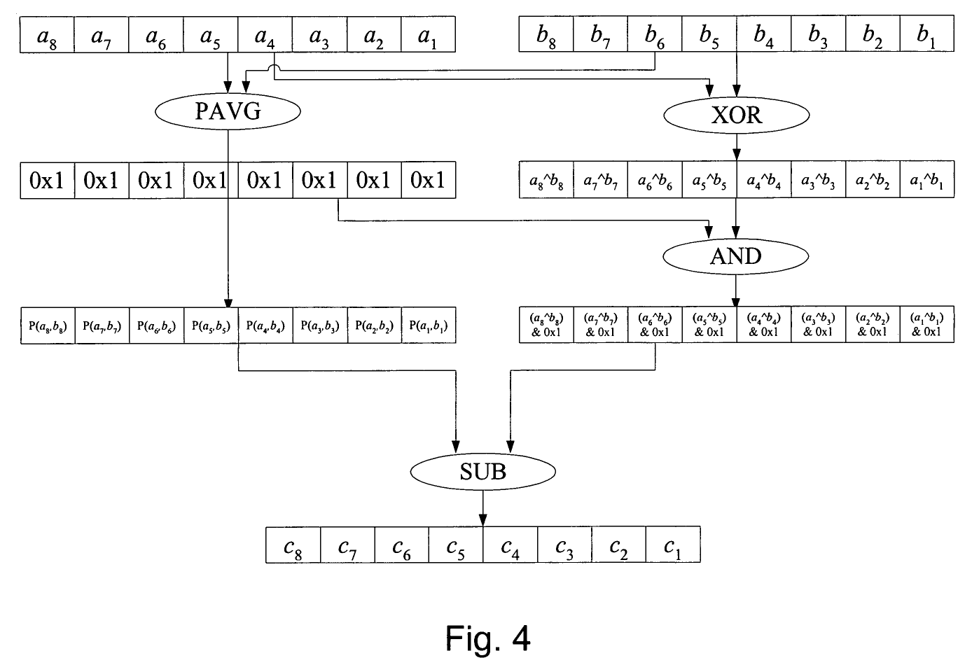

The PAVG operation with adjustment is shown in FIG. 4. Assuming sufficient memory, only 4 instructions instead of the previous 9 instructions (without using PAVG) are needed to achieve the packed operation C=(A+B)>>1. This is an approximate speedup of 9/4=2.25 times.

A preferred embodiment of the invention achieves the same computational result as in FIG. 4 with even fewer instructions by appropriately using the PAVG instruction in combination with supplemental logical operations to adjust for the rounded-up average. As described below, several FIR filtering operations can be modified to obtain result in fewer instructions when compared to conventional SIMD implementations.

Without loss of generality, let A₁, A₂, . . . ,A₁₆ be 16 vectors, each of which contain 8 packed data elements. For example, A₅ contains 8 data elements A₅=[a_{(5,1)}, . . . , a_{(5,8})]. Each data element a_{(1,i)}, . . . , a_{(16,i)} for i=1, . . . 8, is within the range [0,255], i.e., they are represented by bytes, and A₁, . . . ,A₁₆ are packed 64-bit registers:
Aⱼ=[a_{(j,1)}, . . . , a_{(j,8)}] for j=1, . . . ,16 (4)

We perform various operations on the packed 64-bit registers A₁, . . . , A₁₆ to obtain different FIR filters described below. We define packed 64-bit vectors/registers ONE and ONE₄ as follows:
ONE=[0x01, 0x01, 0x01, 0x01, 0x01, 0x01, 0x01, 0x01],
ONE₄=[0x0001, 0x0001, 0x0001, 0x0001], (5)
where 0x01 is a byte containing 1 in its least significant bit and 0's elsewhere. The packed 64-bit register ONE contains 8 packed bytes, each containing 0x01. On the other hand, the packed 64-bit register ONE₄ contains 4 packed words (16 bits), each containing 0x0001.

The FIR filters used in a preferred embodiment include:
1. Type 1 Filter:
   (A₁+A₂+c*ONE)>>1, where c∈{−2,−1,0,1,2}, (6)
2. Type 2 Filter:
   (A₁+A₂+A₃+A₄+c*ONE)>>2, where c∈{0,1,2}, (7)
3. Type 3 Filter:
   (A₁+A₂+A₃+A₄+A₅+A₆+A₇+A₈+c*ONE)>>3, where c∈{0,1,2,3,4}, (8)
4. Type 4 Filter:
   (A₁+A₂+. . . +A₁₅+A₁₆+c*ONE)>>4, where c∈{0,1,2,3,4,5,6,7,8}. (9)

All 4 types of FIR filters are useful for video compression applications. There are numerous FIR filters that can be constructed from these 4 basic types, in addition to those described herein. For example, the filter (2A₁+A₂+A₃+2*ONE)>>2 is a Type 2 filter with A₁=A₄. Similarly, the filter (A₁+2A₂+2A₃+2A₄+A₅+4*ONE)>>3 is a Type 3 filter with A₂=A₆, A₃=A₇, and A₄=A₈. Many other types of filters can be constructed as will be apparent to one of skill in the art.

Instructions according to the present invention can be used to obtain exact filter computations. Such exactness may be necessary as, e.g., in motion compensation and estimation applications where accuracy is key. In other cases an approximation of the filter computation may be sufficient. For example, in cases where the number of operations is large an approximate computation can be a better tradeoff. The approximations of the preferred embodiments produce an error of ±1 in the final result for a small percentage of all values of a_{(j,i)}∈[0,255] for i=1, . . . ,8, and j=1, . . . ,16. These results are useful in cases such as post processing, where a small error of ±1 (in intensity or color value) is inconsequential in the final result. Naturally, other approximations of different degrees of accuracy are possible and are within the scope of the invention.

I. Type 1 FIR Filters

There are 5 variations of the Type 1 FIR filters (A₁+A₂+c*ONE), where c∈{−2, −1,0,1,2}, based on the 5 choices of constant c. We state the SIMD implementation for each of these filters:
(A₁+A₂−2*ONE)>>1=PAVG(A₁,A₂)−ONE−(A₁\hat{ }A₂) & ONE, (10)
(A₁+A₂−ONE)>>1=CLIP(PAVG(A₁\hat{ }A₂)−ONE), (11)
(A₁+A₂)>>1=PAVG(A₁,A₂)−(A₁\hat{ }A₂) & ONE, (12)
(A₁+A₂+ONE)>>1=PAVG(A₁,A₂), (13)
(A₁+A₂+2*ONE)>>1=PAVG(A₁,A₂)+(˜(A₁\hat{ }A₂) & ONE). (14)

There is a less efficient solution for (A₁+A₂)>>1 that will be used to simplify expressions:
(A₁+A₂)>>1=(A₁>>1)+(A₂>>1)+(A₁ & A₂ & ONE). (15)

Although (15) uses more instructions that (12), we need this expression to evaluate other filters. In (15), (A₁ & A₂ & ONE) is a correction term that is necessary when both A₁, and A₂ contain odd integers. An approximate solution for (A₁+A₂)>>1 is:
(A₁+A₂)>>1≅PAVG(CLIP(A₁−ONE),A₂) or PAVG(A₁,CLIP(A₂−ONE)). (16)

In most processors, subtract and CLIP( ) can be realized in one instruction. So the implementations in (16) require only 2 instructions.

II. Type 2 FIR Filters

There are 3 variations of Type 2 filters (7) based on the 3 choices of constant c, where c∈{0,1,2}. We show the derivation of each filter. We define the following 64-bit packed registers, each containing 8 data elements of one byte each:
B₁=PAVG(A₁,A₂), B₂=PAVG(A₃,A₄), EB₁=(A₁\hat{ }A₂), EB₂=(A₃\hat{ }A₄). (17)
A. Type 2, Filter 1: R=(A₁+A₂+A₄+A₄+2*ONE)>>2
i. Conventional SIMD Solution

This filter can be implemented in SIMD architecture (assuming sufficient memory) by using the following steps:
1. (4 Instructions) A_{iL}=Unpack Low 4 Bytes of A₁, for i={1,2,3,4},
2. (4 Instructions) A_{iH}=Unpack High 4 Bytes of A₁, for i={1,2,3,4},
3. (5 Instructions) Add and Shift lower 4 words of A₁, . . . ,A₄ to obtain lower 4 words of R_{L} as:
   R_{L}=(A_{1L}+A_{2L}+A_{3L}+A_{4L}+2*ONE₄)>>2,
4. (5 Instructions) Add and Shift higher 4 words of A₁, . . . ,A₄ to obtain higher 4 words of R_{H} as:
   R_{H}=(A_{1H}+A_{2H}+A_{3H}+A_{4H}+2*ONE₄)>>2,
5. (1 Instruction) Pack R_{H} and R_{L} into final register R.
   We require 19 instructions to perform this filter by conventional SIMD methods.
   ii. Efficient SIMD Solution

In order to implement this filter efficiently, we simplify as follows:
R=(((A₁+A₂+ONE)>>1)+((A₃+A₄+ONE)>>1)+E)>>1=(B₁+B₂+E)>>1, (18)
where E is the correction term that is necessary when both (A₁+A₂+ONE) and (A₃+A₄+ONE) are odd integers as in (15). Detection of odd or even integers is performed with the functions ODD( ) and EVEN( ). Where ODD( ) returns “1” for each packed argument value only if the packed argument value is an odd number and returns “0” otherwise, and where EVEN( ) returns “1” for each packed argument value only if the packed argument value is an even number and returns “0” otherwise.

$$\begin{matrix}E = ODD ( {A}_{1} + {A}_{2} + ONE ) \& ODD ( {A}_{3} + {A}_{4} + ONE ) \\ = EVEN ( {A}_{1} + {A}_{2} ) \& EVEN ( {A}_{3} + {A}_{4} ) \\ = \sim ( {A}_{1} \hat{} {A}_{2} ) \& \sim ( {A}_{3} \hat{} {A}_{4} ) \& ONE \\ = \sim ( {EB}_{1} \vert {EB}_{2} ) \& ONE .\end{matrix} \qquad ( 19 )$$

We note that E∈{0,1}. From (18) and (12), we have:

$$R = \{ \begin{matrix}PAVG ( {B}_{1} , {B}_{2} ) - ( {B}_{1} \hat{} {B}_{2} ) \& ONE & when E = 0 \\ PAVG ( {B}_{1} , {B}_{2} ) & when E = 1\end{matrix} . \qquad ( 20 )$$

We simplify (20) as:
R=PAVG(B₁,B₂)−(B₁\hat{ }B₂) & ˜E & ONE,
which is same as:
R=PAVG(B₁,B₂)−(B₁\hat{ }B₂) & ((A₁\hat{ }A₂)|(A₃\hat{ }A₄)) & ONE. (21)
The solution in (21) requires 10 instructions. We have an approximate 19:10 (approx. 2:1) speedup by using (21).
iii. Approximate SIMD Solution

Besides the accurate solution, we can obtain an approximate solution in fewer instructions by assuming the least significant bit of EB₁ or EB₂ as 0 or 1. Assuming the least significant bit of EB₁ or EB₂=1, we get:
R≅PAVG(B₁,B₂)−(B₁\hat{ }B₂) & ONE. (22)
This solution requires 6 instructions, and according to (16), it is close to the following:
R≅PAVG(CLIP(B₁−ONE),B₂) or R≅PAVG(B₁,CLIP(B₂−ONE)). (23)
This solution requires only 4 instructions, and produces a maximum error of ±1 in the final result for 12.5% of all possible values of A₁, . . . ,A₄ between [0,255]. The error never exceeds ±1. We get a computational efficiency of 19:4, nearly 5 times speedup.
B. Type 2, Filter 2: R=(A₁+A₂+A₃+A₁+ONE)>>2
i. Efficient SIMD Solution

As seen in Section 3.A, this filter can be implemented by conventional SIMD methods in 19 instructions. For efficient implementation, we simplify as follows:
R=(((A₁+A₂+ONE)>>1)+((A₃+A₄)>>1)+E)>>=(B₁+B₂+(E−(EB₂&ONE)))>>1. (24)
Here EB₂ is due to the correction term in (12), and E is the correction term in (15) as:

$$\begin{matrix}E = ODD ( {A}_{1} + {A}_{2} + ONE ) \& ODD ( {A}_{3} + {A}_{4} ) \\ = EVEN ( {A}_{1} + {A}_{2} ) \& ODD ( {A}_{3} + {A}_{4} ) \\ = \sim ( {A}_{1} \hat{} {A}_{2} ) \& ( {A}_{3} \hat{} {A}_{4} ) \& ONE \\ = \sim ( {EB}_{1} \& {EB}_{2} ) \& ONE .\end{matrix} \qquad ( 25 )$$

We note that E_{T}=(E−(EB₂&ONE))∈{0,−1}. From (24), (11), and (12) we obtain:

$$R = \{ \begin{matrix}PAVG ( {B}_{1} , {B}_{2} ) - ( {B}_{1} \hat{} {B}_{2} ) \& ONE & when {E}_{T} = 0 \\ PAVG ( {B}_{1} , {B}_{2} ) - ONE & when {E}_{T} = - 1\end{matrix} . \qquad ( 26 )$$

Note that (E−(EB₂&ONE))=−1 when (A₁\hat{ }A₂) & (A₃\hat{ }A₄) & ONE=1. We simplify (26) as:
R=PAVG(B₁,B₂)−((B₁\hat{ }B₂)|((A₁\hat{ }A₂) & (A₃\hat{ }A₄))) & ONE. (27)
The solution in (27) requires 10 instructions, an approximate 19:10 (nearly 2 times) speedup.
ii. Approximate SIMD Solution

We can obtain four approximations of (27) by assuming the least significant bit of EB₁ or EB₂ as 0 or 1. A good approximate solution is with the assumption that the least significant bit of EB₂=0, which gives us the same solutions as (22) and (23), which require 4 instructions and has a maximum error of ±1 for 12.5% of all possible values of A₁, . . . , A₄∈[0,255]. We get a computational advantage of 19:4.

C. Type 2, Filter 3: R=(A₁+A₂+A₄+A₄)>>2

i. Efficient SIMD Solution

The filter can be implemented by conventional SIMD methods in 17 instructions. For efficient implementation, we simplify as follows:
R=(((A₁+A₂)>>1)+((A₃+A₄)>>1)+E)>>1=(B₁+B₂+(E−(EB₁+EB₂)&ONE))>1. (28)
Here EB₁ and EB₂ are due to the correction term in (12), and E is the correction term in (15) as:
E=ODD(A₁+A₂) & ODD(A₃+A₄)=(A₁\hat{ }A₂) & (A₃\hat{ }A₄) & ONE=EB₁ & EB₂ & ONE. (29)
We note that E_{T}=(E−(EB₁+EB₂)&ONE)∈{0,−1}, and R is same as (26). Note that E_{T}=−1 when (A₁\hat{ }A₂)|(A₃\hat{ }A₄) & ONE=1. We simplify (26) as:
R=PAVG(B₁,B₂)−((B₁\hat{ }B₂)|(A₁\hat{ }A₂)|(A₃\hat{ }A₄)) & ONE. (30)
The solution in (30) requires 10 instructions. We have an approximate 17:10 speedup by using (30).
ii. Approximate SIMD Solution

We can obtain four approximations of (30) by assuming the least significant bit of EB₁ or EB₂ as 0 or 1. A good approximate solution is with the assumptions that the least significant bits of EB₁ or EB₂=1, which gives us:
R≅CLIP(PAVG(B₁,B₂)−ONE). (31)
This solution requires 4 instructions and has a maximum error of ±1 for 12.5% of all possible values of A₁, . . . ,A₄∈[0,255]. We have a computational advantage of 17:4, approx. 4 times.
D. Type 2, Special Filter 1: R=(2A₁+A₃+A₄+2*ONE)>>2

This filter is same as Filter 1 with A₁=A₂. It can be implemented by conventional SIMD methods in, e.g., 17 instructions. This type of filter is used extensively in, for example, standards proposed by the Joint Video Team (JVT) as, for example, in [CHANGE THIS—CHANCHAL TO UPDATE TO MORE CURRENT REFERENCE→ISO/IEC MPEG and ITU-T VCEG, Geneva, Switzerland, Oct., 02; entitled “Editor's Proposed Draft Text Modifications for Joint Video Specification (ITU-T Rec. H.264|ISO/IEC 14496-10 AVC), Geneva modifications, draft 26.and other coding schemes.←END REFERENCE]

We can simplify (21) as:
R=PAVG(A₁,B₂)−(A₁\hat{ }B₂) & (A₃\hat{ }A₄) & ONE. (32)
This solution requires 7 instructions. One can verify that (32) is close to the following:
R≅PAVG(A₁,PAVG(CLIP(A₃−ONE),A₄)), (33)
which requires only 3 instructions instead of 17 instructions by conventional SIMD methods, a nearly 6 times speedup. However, (33) produces an error of ±1 for a very small 0.1% of all possible values of A₁, . . . , A₄ E[0,255].
E. Type 2, Summary of Results

Table II below summarizes the instructions required to compute each filter (given sufficient memory) by the efficient and conventional SIMD methods. For the Efficient case, we give the instructions required for the exact and approximate solutions.

### Summary of Results for Type 2 FIR Filters

TABLE II

| | | Efficient | | | |
|---|---|---|---|---|---|
| | Conventional | Method | | Speedup | |
| Type 2 Filters | Method | Exact | Approx. | Exact | Approx. |
| (A₁ + A₂ + A₃ + A₄ + | 19 | 10 | 4 | 1.9 | 4.75 |
| 2 * ONE) >> 2 | | | | | |
| (A₁ + A₂ + A₃ + A₄ + | 19 | 10 | 4 | 1.9 | 4.75 |
| ONE) >> 2 | | | | | |
| (A₁ + A₂ + A₃ + | 17 | 10 | 4 | 1.7 | 4.25 |
| A₄) >> 2 | | | | | |
| (2A₁ + A₂ + A₃ + | 17 | 7 | 3 | 2.4 | 5.67 |
| 2 * ONE) >> 2 | | | | | |

The shaded areas show significant improvements in efficiency due to the analyses developed here.

3. Type 3 FIR Filters

There are 5 different Type 3 FIR filters depending on the 5 choices of c in (8). We define the following packed 64-bit registers, each containing 8 data elements of one byte each:
B₁=PAVG(A₁,A₂), B₂=PAVG(A₃,A₄), B₃=PAVG(A₅,A₆), B₄=PAVG(A₇,A₈),
C₁=PAVG(B₁,B₂), C₂=PAVG(B₃,B₄),
EB₁=(A₁\hat{ }A₂), EB₂=(A₃\hat{ }A₄), EB₃=(A₅\hat{ }A₆), EB₄=(A₇\hat{ }A₈),
EC₁=(B₁\hat{ }B₂), EC₂=(B₃\hat{ }B₄).tm (34)
A. Type 3, Filter 1: R=(A₁+A₂+A₃+A₄+A₅+A₆+A₇+A₈+4*ONE)>>3
i. Conventional SIMD Solution

This filter can be implemented in SIMD architecture (assuming sufficient memory) by using the following steps:
1. (8 Instructions) A_{iL}=Unpack Low 4 Bytes of A₁, for i=1, . . . ,8,
2. (8 Instructions) A_{iH}=Unpack High 4 Bytes of Aᵢ, for i=1 . . . ,8,
3. (9 Instructions) Add and Shift lower 4 words of A₁, . . . ,A₈ to obtain lower 4 words of R_{L} as:
   R_{L}=(A_{1L}+A_{2L}+A_{3L}+A_{4L}+A_{5L}+A_{6L}+A_{7L}+A_{8L}+4*ONE₄)>>3,
4. (9 Instructions) Add and Shift higher 4 words of A₁, . . . ,A₈ to obtain higher 4 words of _{RH} as:
   R_{H}=(A_{1H}+A_{2H}+A_{3H}+A_{4H}+A_{5H}+A_{6H}+A_{7H}H+A_{8H}+4*ONE₄)>>3,
5. (1 Instruction) Pack R_{H} and R_{L} into final register R.
   We require 35 instructions to compute this filter by conventional SIMD methods.
   ii. New SIMD Solution

In order to implement this filter without unpacking, we simplify it as follows:
R=(((A₁+A₂+A₃+A₄+2*ONE)>>2)+((A₅+A₆+A₇+A₈+2*ONE)>>2)+E)>>1, (35)
where E is the error/correction term that is necessary for dividing up the expression into two parts each containing a Type 2, Filter 1 (21). Note that according to (21) and the registers in (34), we have:
(A₁+A₂+A₃+A₄+2*ONE)>>2=C₁−(E₁ & ONE),
(A₅+A₆+A₇+A₈+2*ONE)>>2=C₂−(E₂ & ONE), (36)
where E₁=EC₁ & (EB₁|EB₂) and E₂=EC₂ & (EB₃|EB₄) are error/correction terms obtained in (21). We can simplify (35) as:
R=(C₁+C₂+(E−E₁−E₂)&ONE)>>1. (37)
We now find the expression for E in terms of the packed 64-bit registers in (34). The simplification in (35), amounts to the following:
(P+Q)>>3=((P>>2)+(Q>>2)+E)>>1, (38)
where P and Q are unsigned integers. Let p₀ be the least significant bit of P and p₁ the next significant bit of P. Similarly, let q₀ be the least significant bit of Q and q, the next significant bit of Q. The simplification in (38) results in an error E when the last 2 bits of P and Q add up to a number ≧4. The condition that determines this error E is:
(p₁ & qₗ)|(p₀ & q₀ &(p₁|q₁)).
We can prove that p₁, p₀, q₁, q₀ can be expressed in terms of the registers in (34) as the least significant bits of the following packed 64-bit registers respectively:
P₁=(EC₁\hat{ }˜(EB₁|EB₂)),
P₀=(EB₁\hat{ }EB₂),
Q₁=(EC₂\hat{ }˜(EB₃|EB₄)),
Q₀=(EB₃\hat{ }EB₄), (39)
From (39), we can express E as the least significant bit of:
E=(P₁ & Q₁)|(P₀ & Q₀ & (P₁|Q₁)). (40)
We note that E∈{0, 1}, and E_{T}=(E−E₁−E₂)∈{−1, 0, 1}. From (37), we have:

$$R = \{ \begin{matrix}PAVG ( {C}_{1} , {C}_{2} ) - ONE & when {E}_{T} = - 1 \\ PAVG ( {C}_{1} , {C}_{2} ) - ( {C}_{1} \hat{} {C}_{2} ) \& ONE & when {E}_{T} = 0 \\ PAVG ( {C}_{1} , {C}_{2} ) & when {E}_{T} = 1\end{matrix} . \qquad ( 41 )$$

We simplify (41) as:
R=PAVG(C₁,C₂)−((C₁\hat{ }C₂)|(E₁\hat{ }E₂\hat{ }E)) & (E₁|E₂|˜E) & ONE, (42)
where E₁=EC₁ & (EB₁|EB₂) and E₂=EC₂ & (EB₃|EB₄). We can further simplify (42) as an expression in terms of EC₁, EC₂, EB₁, EB₂, EB₃, and EB₄ so that we can skip the computations of E₁, E₂, and E as follows:
U=EC₁|EC₂,
V=EB₁|EB₂,
W=EB₃|EB₄,
X=V|W,
Y=U|X,
Z=(EC₁ & EC₂ & X),
T=U & V & W & ((EB₁ & EB₂)|(EB₃ & EB₄)),
R=PAVG(C₁,C₂)−((C₁\hat{ }C₂)|Z|T) & Y & ONE, (43)

The solution in (43) is shown in pseudo-code in Table III, below. Any suitable language, coding technique, circuitry or combination of hardware and software can be used to achieve the functionality shown in the pseudo-code presented herein. The approach of Table III uses 32 instructions as compared to the conventional 35 instructions. The count of 32 instructions is obtained by counting each logical and arithmetic operation of (43) along with those of (34). Other instruction counts in this application are obtained, similarly. Clearly, the approach of Table III is not as efficient as the Type 2 algorithms. However, there are at least 2 benefits of this approach:
(1) We can systematically arrive at approximate solutions by making assumptions on the error/correction terms EC₁, EC₂, EB₁, EB₂, EB₃, and EB₄ (see Section 3.A.iii).

(2) In special cases, where various Aᵢ's are same, we can simplify the computation considerably and obtain efficient exact and approximate solutions (see Sections 3.F-3.H).

TABLE III

#define P(a,b) (((a) + (b) + 1) >> 1)
b1 = P(a01,a02);
b2 = P(a03,a04);
b3 = P(a05,a06);
b4 = P(a07,a08);
c1 = P(b1,b2);
c2 = P(b3,b4);
d = P(c1,c2);
eb1 = a0l \hat{ } a02;
eb2 = a03 \hat{ } a04;
eb3 = a05 \hat{ } a06;
eb4 = a07 \hat{ } a08;
ec1 = b1 \hat{ } b2;
ec2 = b3 \hat{ } b4;
ed = c1 \hat{ } c2;
u = ec1 | ec2;
v = eb1 | eb2;
w = eb3 | eb4;
x = v | w;
y = u | x;
z = ec1 & ec2 & x;
t = u & v & w & ((eb1 & eb2) | (eb3 & eb4));
e = ((ed & y) | z | t) & 0x01; // Exact solution
x1 = CLIP(d − e);

iii. Approximate SIMD Solution

We have many approximate solutions by assuming the least significant bit of EB₁, EB₂, EB₃, EB₄, EC₁, or EC₂ as 0 or 1. With the assumption that the least significant bit of EB₁=1, and EB₂=EB₃=EB₄=0, we get from (43):
R=PAVG(C₁,C₂)−((C₁\hat{ }C₂)|(EC₁ & EC₂)) & ONE. (44)

An example pseudo-code implementation of this solution is shown in Table IV, below. This approach uses 14 instructions, and produces a maximum error of ±1 in the final result for 9.38% of all possible values of A₁, . . . ,A₈ between [0,255]. The error never exceeds ±1. This solution with 14 instructions, and a maximum error of ±1 for less than 1/10^{th} of the data is acceptable in many applications like post-processing, where a difference of 1 gray value in the displayed frame is imperceptible to most of us. Yet, we receive a computational advantage of 35:14.

The second approximate solution makes the assumption EB₁=0, and EB₂=1. It produces the following solution:
T=(EC₁|EC₂) & (EB₃|EB₄) & EB₃ & EB₄,
R=PAVG(C₁,C₂)−((C₁\hat{ }C₂)|(EC₁ & EC₂)|T) & ONE, (45)

This solution requires 22 instructions, and produces a maximum error of ±1 in the final result for 6.25% of all possible values of A₁, . . . ,A₈ between [0,255].

TABLE IV

#define P(a,b) (((a) + (b) + 1) >> 1)
b1 = P(a01,a02);
b2 = P(a03,a04);
b3 = P(a05,a06);
b4 = P(a07,a08);
c1 = P(b1,b2);
c2 = P(b3,b4);
d = P(c1,c2);
ec1 = b1 \hat{ } b2;
ec2 = b3 \hat{ } b4;
ed = c1 \hat{ } c2;
e = (ed | (ec1 & ec2)) & 0x01; //approx = 9.375%
x1 = CLIP(d − e);

B. Type 3, Filter 2: R=(A₁+A₂+A₃+A₄+A₅+A₆+A₇+A₈+3*ONE)>3

We require 35 instructions to compute this filter by conventional SIMD methods. For the new SIMD solution, we write the filter as:
R=(((A₁+A₂+A₃+A₄+2*ONE)>>2)+((A₅+A₆+A₇+A₈+ONE)>>2)+E)>>1,
where E is the error/correction term that is necessary for dividing up the expression into two parts each containing a Type 2 Filter. We have:
R=(C₁+C₂+(E−E₁−E₂)&ONE)>>1,
(A₁+A₂+A₃+A₄+2*ONE)>>2=C₁−(E₁ & ONE),
(A₅+A₆+A₇+A₈+ONE)>>2=C₂−(E₂ & ONE),
E₁=EC₁ & (EB₁|EB₂), E₂=EC₂|(EB₃ & EB₄),
P₁=(EC₁\hat{ }(EB₁|EB₂)), P₀=(EB₁\hat{ }EB₂),
Q₁=(EC₂\hat{ }(EB₃ & EB₄)), Q₀=˜(EB₃\hat{ }EB₄),
E=(P₁ & Q₁)|(P₀ & Q₀ & (P₁|Q₁)).
Here E₁ and E₂ are error/correction terms obtained from (21) and (27) respectively. Defining E_{T}=(E−E₁−E₂)∈{−2, −1, 0}, we have:

$$R = \{ \begin{matrix}PAVG ( {C}_{1} , {C}_{2} ) - ( {C}_{1} \hat{} {C}_{2} ) \& ONE & when {E}_{T} = 0 \\ PAVG ( {C}_{1} , {C}_{2} ) - ONE & when {E}_{T} = - 1 \\ PAVG ( {C}_{1} , {C}_{2} ) - ONE - ( {C}_{1} \hat{} {C}_{2} ) \& ONE & when {E}_{T} = - 2\end{matrix} . \qquad ( 46 )$$

We simplify (46) as:
S=(E₁\hat{ }E₂\hat{ }E),
R=PAVG(C₁,C₂)−((E₁ & E₂ & E)|S) & ONE−((C₁\hat{ }C₂) & ˜S) & ONE, (47)
This solution can be further simplified as:
P=EB₃ & EB₄,
U=EB₁ & EB₂& P,
V=EC₁ & EC₂,
W=EB₃|EB₄,
X=(EC₁|EC₂) & ((EB₁ & (EB₂|W))|(EB₂ & W)|P),
Y=(X|V|U),
ED=(C₁\hat{ }C₂),
R=PAVG(C₁,C₂)−((ED|Y) & ONE)−(U & V & ED & ONE). (48)
The solution in (47) requires 35 instructions, same as the conventional 35 instructions.

An approximate solution of (47) can be obtained with the assumption that the least significant bit of EB₁=EB₂=1, and EB₃=EB₄=0 is:
R=PAVG(C₁,C₂)−((C₁\hat{ }C₂)|EC₁|EC₂) & ONE. (49)

This solution requires 14 instructions, and produces a maximum error of ±1 in the final result for 9.38% of all possible values of A₁, . . . ,A₈ between [0,255]. We receive a computational advantage of 35:14.

The second approximate solution makes the assumption EB1=1, and EB2=0. It produces the following solution:
Y=((EC₁|EC₂) & (EB₃|EB₄))|(EC₁ & EC₂),
R=PAVG(C₁,C₂)−((C₁\hat{ }C₂)|Y) & ONE. (50)
This solution requires 20 instructions, and produces a maximum error of ±1 in the final result for 6.25% of all possible values of A₁, . . . ,A₈ between [0,255].
C. Type 3, Filter 3: R=(A₁+A₂+A₃+A₄+A₅+A₆+A₇+A₈+2*ONE)>>3

We require 35 instructions to compute this filter by conventional SIMD methods. For the new SIMD solution, we write the filter as:
R=(((A₁+A₂+A₃+A₄+ONE)>>2)+((A₅+A₆+A₇+A₈+ONE)>>2)+E)>>1,
where E is the error/correction term that is necessary for dividing up the expression into two parts each containing a Type 2, Filter 2 (27). We have:
R=(C₁+C₂+(E−E₁−E₂)&ONE)>>1,
(A₁+A₂+A₃+A₄+ONE)>>2=C₁−(E₁ & ONE),
(A₅+A₆+A₇+A₈+ONE)>>2=C₂−(E₂ & ONE),
E₁=EC₁|(EB₁ & EB₂), E₂=EC₂|(EB₃ & EB₄),
P₁=(EC₁\hat{ }(EB₁ & EB₂)), P₀=˜(EB₁\hat{ }EB₂),
Q₁=(EC₂\hat{ }(EB₃ & EB₄)), Q₀=˜(EB₃\hat{ }EB₄),
E=(P₁ & Q₁)|(P₀ & Q₀ & (P₁|Q₁)).
Here E₁ and E₂ are error/correction terms obtained from (27). Defining E_{T}=(E−E₁−E₂)∈{−2, −1, 0}, we have the same expression for R as in (46), which we simplify as:
S=(E₁\hat{ }E₂),
R=PAVG(C₁,C₂)−(˜(E & S) & (E₁|E₂|E)) & ONE−((C₁\hat{ }C₂) & ˜(S\hat{ }E)) & ONE. (51)

This solution can be further simplified as:
P=EB₁|EB₄,
Q=EB₃|EB₂,
U=(EB₂ & EB₃ & P)|(EB₄ & EB₁ & Q),
V=EC, & EC₂,
W=P|Q,
ED=(C₁\hat{ }C₂),
R=PAVG(C₁,C₂)−(ED|U|V|((EC₁|EC₂) & W)) & ONE−ED & U & V & ONE. (52)

The solution in (52) requires 34 instructions, close to the conventional 35 instructions.

The approximate solution requires the assumption that the least significant bit of EB₁=1, and EB₂=EB₃=EB₄=0 is:
R=PAVG(C₁,C₂)−((C₁\hat{ }C₂)|EC₁|EC₂) & ONE. (53)
This solution requires 14 instructions, and produces a maximum error of ±1 in the final result for 9.38% of all possible values of A₁, . . . ,A₈ between [0,255]. We receive a computational advantage of 35:14.

The second approximate solution makes the assumption EB₁=1, and EB₂=0. It produces the following solution:
U=EB₃ & EB₄,
ED=(C₁\hat{ }C₂),
R=PAVG(C₁,C₂)−(ED|U|EC₁|EC₂) & ONE−ED & U & EC₁ & EC₂ & ONE. (54)
This solution requires 23 instructions, and produces a maximum error of ±1 in the final result for 6.25% of all possible values of A₁, . . . ,A₈ between [0,255].
D. Type 3, Filter 4: R=(A₁+A₂+A₃+A₄+A₅+A₆+A₇+A₈+ONE)>>3

We require 35 instructions to compute this filter by conventional SIMD methods. For the new SIMD solution, we write the filter as:
R=(((A₁+A₂+A₃+A₄+ONE)>>2)+((A₅+A₆+A₇+A₈)>>2)+E)>>1,
where E is the error/correction term that is necessary for dividing up the expression into two parts each containing a Type 2, Filter. We have:
R=(C₁+C₂+(E−E₁−E₂)&ONE)>>1,
(A₁+A₂+A₃+A₄+ONE)>>2=C₁−(E₁ & ONE),
(A₅+A₆+A₇+A₈)>>2=C₂−(E₂ & ONE),
E₁=EC₁|(EB₁ & EB₂), E₂=EC₂|EB₃|EB₄,
P₁=(EC₁\hat{ }(EB₁ & EB₂)), P₀=˜(EB₁\hat{ }EB₂),
Q₁=(EC₂\hat{ }(EB₃|EB₄)), Q₀=(EB₃\hat{ }EB₄),
E=(P₁ & Q₁)|(P₀ & Q₀ & (P₁|Q₁)).
Here E₁ and E₂ are error/correction terms obtained from (27) and (30) respectively. Defining E_{T}=(E−E₁−E₂)∈{−2, −1, 0}, we have the same expression for R as in (46), which we simplify as:
S=(E₂\hat{ }E),
R=PAVG(C₁,C₂)−(E₁|S) & ONE−((C₁\hat{ }C₂) & ˜(E₁\hat{ }S)) & ONE, (55)
This solution can be further simplified as:
P=EB₃ & EB₄,
Q=EB₃|EB₄,
U=(EB₁ & (EB₂|Q))|(EB₂ & Q)|P,
V=EB₁ & EB₂& P,
W=EC₁|EC₂,
Z=(EC₁ & EC₂& U),
ED=(C₁\hat{ }C₂),
R=PAVG(C₁,C₂)−(ED|U|P) & ONE−ED & ((W & V)|Z) & ONE. (56)
The solution in (56) requires 35 instructions, same as the conventional 35 instructions. The approximate solution requires the assumption that the least significant bit of EB₁=EB₂=0, and EB₃=EB₄=1 is:
R=PAVG(C₁,C₂)−ONE−((C₁\hat{ }C₂) & EC₁ & EC₂) & ONE. (57)
This solution requires 15 instructions, and produces a maximum error of ±1 in the final result for 9.38% of all possible values of A₁, . . . ,A₈ between [0,255]. We receive a computational advantage of 35:15.

The second approximate solution makes the assumption EB₁=1, and EB₂=0. It produces the following solution:
Q=EB₃|EB₄,
Z=(EC₁ & EC₂ & Q),
ED=(C₁\hat{ }C₂),
R=PAVG(C₁,C₂)−((ED|Q|EC₁|EC₂) & ONE)−(ED & Z & ONE). (58)
This solution requires 23 instructions, and produces a maximum error of ±1 in the final result for 6.25% of all possible values of A₁, . . . ,A₈ between [0,255].
E. Type 3, Filter 5: R=(A₁+A₂+A₃+A₄+A₅+A₆+A₇+A₈)>>3

We require 33 instructions to compute this filter by conventional SIMD methods. For the new SIMD solution, we write the filter as:
R=(((A₁+A₂+A₃+A₄)>>2)+((A₅+A₆+A₇+A₈)>>2)+E)>>1,
where E is the error/correction term that is necessary for dividing up the expression into two parts each containing a Type 2, Filter (30). We have:
R=(C₁+C₂+(E−E₁−E₂)&ONE)>>1,
(A₁+A₂+A₃+A₄)>>2=C₁−(E₁ & ONE),
(A₅+A₆+A₇+A₈)>>2=C₂−(E₂ & ONE),
E₁=EC₁|EB₁|EB₂, E₂=EC₂|EB₃|EB₄,
P₁=(EC₁\hat{ }(EB₁|EB₂)), P₀=(EB₁\hat{ }EB₂),
Q₁=(EC₂\hat{ }(EB₃|EB₄)), Q₀=(EB₃\hat{ }EB₄),
E=(P₁ & Q₁)|(P₀ & Q₀ & (P₁|Q₁)).
Here E₁ and E₂ are error/correction terms obtained from (27) and (30) respectively. Defining ET=(E−E₁−E₂)∈{−2, −1, 0}, we have the same expression for R as in (46), which we simplify as:
R=PAVG(C₁,C₂)−(E₁|E₂) & ONE−((C₁\hat{ }C₂) & ˜(E₁\hat{ }E₂\hat{ }E)) & ONE, (59)
This solution can be simplified as:
P=EB₁|EB₄,
Q=EB₃|EB₂,
U=P|Q,
V=(EB₂ & EB₃ & P)|(EB₄ & EB₁ & Q),
W=EC₁|EC₂,
Z=(EC₁ & EC₂& U),
ED=(C₁\hat{ }C₂),
R=PAVG(C₁,C₂)−((ED|U|W) & ONE)−(ED & ((W & V)|Z) & ONE). (60)
The solution in (59) requires 34 instructions, close to the conventional 35 instructions.

The approximate solution requires the assumption that the least significant bit of EB₁=1, and EB₂=EB₃=EB₄=0 is:
R=PAVG(C₁,C₂)−ONE−(C₁\hat{ }C₂) & EC₁ & EC₂ & ONE. (61)
This solution requires 15 instructions, and produces a maximum error of ±1 in the final result for 9.38% of all possible values of A₁, . . . ,A₈ between [0,255]. We receive a computational advantage of 33:15.

The second approximate solution makes the assumption EB1=1, and EB2=0. It produces the following solution:
W=EC₁|EC₂,
R=PAVG(C₁,C₂)−ONE−((C₁\hat{ }C₂) & ((W & EB₃ & EB₄)|(EC₁ & EC₂)) & ONE). (62)

This solution requires 21 instructions, and produces a maximum error of ±1 in the final result for 6.25% of all possible values of A₁, . . . ,A₈ between [0,255].

F. Type 3, Special Filter 1: R=(A₁+2A₃+2A₅+2A₇+A₂+4*ONE)>>3

This filter is an important loop filter for de-blocking in JVT video compression standards.

i. Conventional SIMD Solution

This filter can be implemented in SIMD architecture (assuming sufficient memory) by using the following steps:
1. (5 Instructions) A_{iL}=Unpack Low 4 Bytes of Aᵢ, for i∈{1,2,3,5,7},
2. (5 Instructions) A_{iH}=Unpack High 4 Bytes of Aᵢ, for i∈{1,2,3,5,7},
3. (9 Instructions) Add and Shift lower 4 words of A₁, . . . ,A₅ to obtain lower 4 words of R_{L} as:
   R_{L}=(A_{1L}+2A_{3L}+2A_{5L}+2A_{7L}+A_{2L}+4*ONE₄)>>3,
4. (9 Instructions) Add and Shift higher 4 words of A₁, . . . ,A₅ to obtain higher 4 words of R_{H} as:
   R_{H}=(A_{1H}+2A_{3H}+2A_{5H}+2A_{7H}+A_{2H}+4*ONE₄)>>3,
5. (1 Instruction) Pack R_{H} and R_{L} into final register R.
   We require 29 instructions to compute this filter by conventional SIMD methods.
   ii. Efficient SIMD Solution

From (34), we get the:
B₁=PAVG(A₁,A₂), B₂=A₃, B₃=A₅, B₄=A₇,
C₁=PAVG(B₁,A₃), C₂=PAVG(A₅,A₇),
EB₁=(A₁\hat{ }A₂), EB₂=0, EB₃=0, EB₄=0,
EC₁=(B₁\hat{ }A₃), EC₂=(A₅\hat{ }A₇). (63)
In (43) we get:
R=PAVG(C₁,C₂)−((C₁\hat{ }C₂)|(EC₁ & EC₂ & EB₁)) & (EC₁|EC₂|EB₁) & ONE. (64)
The solution in (64) requires 16 instructions with a computational benefit of 29:16.
iii. Approximate SIMD Solution

The approximate solution with the assumptions that the least significant bit of EB₁=EC₁=0, and EC₂=1 is:
R=PAVG(C₁,C₂)−(C₁\hat{ }C₂) & ONE. (65)
It requires 7 instructions, and produces a maximum error of ±1 in the final result for 12.5% of all possible values of A₁, . . . ,A₈ between [0,255]. The computational advantage is 29:7 (approx. 4 times speedup).
G. Type 3, Special Filter 2: R=(A₁+A₂+A₃+3A₄+2A₇+4*ONE)>>3

This filter is also an important loop filter for de-blocking in the JVT video compression standard.

i. Conventional SIMD Solution

This filter can be implemented in SIMD architecture (assuming sufficient memory) by using the following steps:
1. (5 Instructions) A_{iL}=Unpack Low 4 Bytes of Aᵢ, for i∈{1,2,3,4,7},
2. (5 Instructions) A_{iH}=Unpack High 4 Bytes of Aᵢ, for i∈{1,2,3,4,7},
3. (8 Instructions) Add and Shift lower 4 words of A₁, . . . ,A₅ to obtain lower 4 words of R_{L} as:
   R_{L}=(A_{1L}+A_{2L}+A_{3L}+3A_{4L}+2A_{7L}+4*ONE₄)>>3,
4. (8 Instructions) Add and Shift higher 4 words of A₁, . . . ,A₅ to obtain higher 4 words of R_{H} as:
   R_{H}=(A_{1H}+A_{2H}+A_{3H}+3A_{4H}+2A_{7H}+4*ONE₄)>>3,
5. (1 Instruction) Pack R_{H} and R_{L} into final register R.

We require 27 instructions (including two multiplications by 3) to compute this filter by conventional SIMD methods.

ii. Efficient SIMD Solution

From (34), we get the:
B₁=PAVG(A₁,A₂), B₂=PAVG(A₃,A₄), B₃=A₄, B₄=A₇,
C₁=PAVG(B₁,B₂), C₂=PAVG(A₄,A₇),
EB₁=(A₁\hat{ }A₂), EB₂=(A₃\hat{ }A₄), EB₃=0, EB₄=0,
EC₁=(B₁\hat{ }B₂), EC₂=(A₄\hat{ }A₇). (66)
In (43) we get:
S=(EB₁|EB₂),
R=PAVG(C₁,C₂)−((C₁\hat{ }C₂)|(EC₁ & EC₂ & S)) & (EC₁|EC₂|S) & ONE. (67)
The solution in (65) requires 19 instructions with a computational benefit of 27:19.
iii. Approximate SIMD Solution

The first approximate solution with the assumptions that the least significant bit of EC₁=EC₂=1, and EB₁=EB₂=0 is:
R=PAVG(C₁,C₂)−(C₁\hat{ }C₂) & ONE. (68)
It requires 8 instructions, and produces a maximum error of ±1 in the final result for 12.5% of all possible values of A₁, . . . ,A₈ between [0,255]. The computational advantage is 27:8.

The next approximate solution is with the assumption that the last bit of EB₁=EB₂=1, which gives us:
R=PAVG(C₁,C₂)−((C₁\hat{ }C₂)|(EC₁ & EC₂)) & ONE. (69)
This solution requires 12 instructions and produces a maximum error of ±1 in the final result for 6.25% of all possible values of A₁, . . . , A₈ between [0,255]. The computational advantage is 27:12.
H. Type 3, Special Filter 3: R=(A₁+A₂+A₃+2A₄+A₅+A₆+A₇+4>ONE)>>3

This filter is used for de-blocking in post-processing.

i. Conventional SIMD Solution

This filter can be implemented in SIMD architecture (assuming sufficient memory) by using the following steps:
1. (7 Instructions) A_{iL}=Unpack Low 4 Bytes of Aᵢ, for i∈{1,2,3,4,5,67},
2. (7 Instructions) A_{iH}=Unpack High 4 Bytes of Aᵢ, for i∈{1,2,3,4,5,67},
3. (9 Instructions) Add and Shift lower 4 words of A₁, . . . ,A₅ to obtain lower 4 words of R_{L} as:
   R_{L}=(A_{1L}+A_{2L}+A_{3L}+2A_{4L}+A_{5L}+A_{6L}+A_{7L}+4*ONE₄)>>3,
4. (9 Instructions) Add and Shift higher 4 words of A₁, . . . ,A₅ to obtain higher 4 words of R_{H} as:
   R_{H}=(A_{1H}+A_{2H}+A_{3H}+2A_{4H}+A_{5H}+A_{6H}+A_{7H}+4*ONE₄)>>3,
5. (1 Instruction) Pack R_{H} and R_{L} into final register R.
   We require 33 instructions to compute this filter by conventional SIMD methods.
   ii. Efficient SIMD Solution

From (34), we get the:
B₁=PAVG(A₁,A₂), B₂=PAVG(A₃,A₅), B₃=PAVG(A₆,A₇), B₄=A₄,
C₁=PAVG(B₁,B₂), C₂=PAVG(B₃,A₄),
EB₁=(A₁\hat{ }A₂), EB₂=(A₃\hat{ }A₄), EB₃=(A₆\hat{ }A₇), EB₄=0,
EC₁=(B₁\hat{ }B₂), EC₂=(B₃\hat{ }A₄). (70)
In (43) we get:
U=EC₁|EC₂,
V=EB₁|EB₂,
X=V|EB₃,
Y=U|X,
Z=(EC₁ & EC₂ & X),
T=U & V & EB₁ & EB₂ & EB₃,
R=PAVG(C₁,C₂)−((C₁\hat{ }C₂)|Z|T) & Y & ONE, (71)
The solution in (71) requires 27 instructions with a computational benefit of 33:27.
iii. Approximate SIMD Solution

We get an approximate solution with the assumptions that the least significant bit of EB₂=1, and EB₂=EB₃=0 as:
R=PAVG(C₁,C₂)−((C₁\hat{ }C₂)|(EC₁ & EC₂)) & ONE. (72)
The solution in (72) requires 13 instructions, and produces a maximum error of ±1 in the final result for 6.25% of all possible values of A₁, . . . ,A₇ between [0,255]. The computational advantage is 33:13.
I. Type 3, Summary of Results

Table V below summarizes the instructions required to compute each filter (given sufficient memory) by the efficient and conventional SIMD methods. For the Efficient case, we give the instructions required for the exact and approximate solutions.

### Summary of Results for Type 3 FIR Filters

TABLE V

| | | Efficient | | | |
|---|---|---|---|---|---|
| | Conventional | Method | | Speedup | |
| Type 3 Filters | Method | Exact | Approx. | Exact | Approx. |
| (A₁ + A₂ + . . . + A₈ + | 35 | 32 | 14 | 1.1 | 2.5 |
| 4 * ONE) >> 3 | | | | | |
| (A₁ + A₂ + . . . + A₈ + | 35 | 35 | 14 | 1.0 | 2.5 |
| 3 * ONE) >> 3 | | | | | |
| (A₁ + A₂ + . . . + A₈ + | 35 | 34 | 14 | 1.0 | 2.5 |
| 2 * ONE) >> 3 | | | | | |
| (A₁ + A₂ + . . . + A₈ + | 35 | 35 | 15 | 1.0 | 2.3 |
| 1 * ONE) >> 3 | | | | | |
| (A₁ + A₂ + . . . + | 33 | 34 | 15 | 1.0 | 2.2 |
| A₈) >> 3 | | | | | |
| (A₁ + 2A₃ + 2A₅ + 2A₇ + | 29 | 16 | 2 | 1.8 | 4.1 |
| A₂ + 4 * ONE) >> 3 | | | | | |
| (A₁ + A₂ + A₃ + 3A₄ + | 27 | 19 | 8 | 1.4 | 3.4 |
| 2A₇ + 4 * ONE) >> 3 | | | | | |
| (A₁ + A₂ + A₃ + 2A₄ + | 33 | 27 | 13 | 1.2 | 2.5 |
| A₅ + A₆ + A₇ + | | | | | |
| 4 * ONE) >> 3 | | | | | |

The shaded areas show significant improvements in efficiency due to the analyses developed here.

4. Type 4 FIR Filters

There are 9 different Type 4 FIR filters depending on the 9 choices of c in (9). For the sake of brevity, we shall only discuss the case of c=8. We define the following packed 64-bit registers, each containing 8 data elements of one byte each:
B₁=PAVG(A₁,A₂), B₂=PAVG(A₃,A₄), B₃=PAVG(A₅,A₆), B₄=PAVG(A₇\hat{ }A₈),
B₅=PAVG(A₉,A₁₀), B₆=PAVG(A₁₁,A₁₂), B₇=PAVG(A₁₃,A₁₄), B₈=PAVG(A₁₅,A₁₆),
C₁=PAVG(B₁,B₂), C₂=PAVG(B₃,B₄), C₃=PAVG(B₅,B₆), C₄=PAVG(B₇,B₈),
D₁=PAVG(C₁,C₂), D₂=PAVG(C₃,C₄),
EB₁=(A₁\hat{ }A₂), EB₂=(A₃\hat{ }A₄), EB₃=(A₅\hat{ }A₆), EB₄=(A₇\hat{ }A₈),
EB₅=(A₉\hat{ }A₁₀), EB₆=(A₁₁\hat{ }A₁₂), EB₇=(A₁₃\hat{ }A₁₄), EB₈=(A₁₅\hat{ }A₁₆),
EC₁=(B₁\hat{ }B₂), EC₂=(B₃\hat{ }B₄), EC₃=(B₅\hat{ }B₆), EC₄=(B₇\hat{ }B₈),
ED₁=(C₁\hat{ }C₂), ED₂=(C₃\hat{ }C₄),
E₁=EC₁ & (EB₁|EB₂), E₂=EC₂ & (EB₃|EB₄),
E₃=EC₃ & (EB₅|EB₆), E₄=EC₄ & (EB₇|EB₈),
P₁=(EC₁\hat{ }˜(EB₁|EB₂)), P₀=(EB₁\hat{ }EB₂),
Q₁=(EC₂\hat{ }˜(EB₃|EB₄)), Q₀=(EB₃\hat{ }EB₄),
ER₁=(P₁ & Q₁)|((P₁|Q₁) & P₀ & Q₀),
R₁=(EC₃\hat{ }˜(EB₅|EB₆)), R₀=(EB₅\hat{ }EB₆),
S₁=(EC₄\hat{ }˜(EB₇|EB₈)), S₀=(EB₇\hat{ }EB₈),
ER₂=(R₁ & S₁)|((R₁|S₁) & R₀ & S₀),
U₂=ED₁\hat{ }E₁\hat{ }E₂\hat{ }((P₁ & Q₁)|((P₁|Q₁) & P₀ & Q₀)),
U₁=P₁\hat{ }Q₁\hat{ }(P₀ & Q₀),
U₀=P₀\hat{ }Q₀,
V₂=ED₂\hat{ }E₃\hat{ }E₄\hat{ }((R₁ & S_{I})|((R₁|S₁) & R₀ & S₀)),
V₁=R₁\hat{ }S₁\hat{ }(R₀ & S₀),
V₀=R₀\hat{ }S₀,
E=(U₂ & V₂)|((U₂|V₂) & U₁ & V₁)|((U₂|V₂) & (U₁|V₁) & U₀ & V₀),
ET₁=(ED₁|(E₁\hat{ }E₂\hat{ }ER₁)) & (E₁|E₂|˜ER₁),
ET₂=(ED₂|(E₃\hat{ }E₄\hat{ }ER₂)) & (E₃|E₄|˜ER₂). (73)
A. Type 4, Filter 1: R=(A₁+A₂+. . . +A₁₅+A₁₆+8*ONE)>>4
i. Conventional SIMD Solution

This filter can be implemented in SIMD architecture (assuming sufficient memory) by using the following steps:
1. (16 Instructions) A_{iL}=Unpack Low 4 Bytes of Aᵢ, for i=1, . . . ,16,
2. (16 Instructions) A_{iH}=Unpack High 4 Bytes of Aᵢ, for i=1, . . . ,16,
3. (17 Instructions) Add and Shift lower 4 words of A₁, . . . ,A₁₆ to obtain lower 4 words of R_{L} as:
   R_{L}=(A_{1L}+A_{2L}+. . . +A_{15L}+A_{16L}+4*ONE₄)>>4,
4. (17 Instructions) Add and Shift higher 4 words of A₁, . . . ,A₆ to obtain higher 4 words of R_{H} as:
   R_{H}=(A_{1H}+A_{2H}+. . . +A_{15H}+A_{16H}+4*ONE₄)>>4,
5. (1 Instruction) Pack R_{H} and R_{L} into final register R.
   We require 67 instructions to compute this filter by conventional SIMD methods.
   ii. Efficient SIMD Solution

In order to implement this filter efficiently, we simplify it as follows:
R=((A₁+A₂+. . . +A₇+A₈+4*ONE)>>3+(A₉+A₁₀+. . . +A₁₅+A₁₆+4*ONE)>>3+E)>1, (74)
where E is the error/correction term that is necessary for dividing up the expression into two parts each containing a Type 3, Filter 1 (42). Note that according to (42) and the registers in (73), we have:
(A₁+A₂+. . . +A₇+A₈+4*ONE)>>3=D₁−(ET₁ & ONE),
(A₉+A₁₀+. . . +A₁₅+A₁₆+4*ONE)>>3=D₂−(ET₂ & ONE), (75)
where ET₁ and ET₂ are error/correction terms obtained in (42). We can simplify (74) as:
R=(D₁+D₂+(E−ET₁−ET₂)&ONE)>>1. (76)
Note that the expressions for E, ET₁, and ET₂ are given in (73). We note that E, ET₁, ET₂∈{0, 1}, and E_{T}=(E−ET₁−ET₂)∈{−2, −1, 0, 1}. From (76), we have:

$$R = \{ \begin{matrix}PAVG ( {D}_{1} , {D}_{2} ) - ONE - ( {D}_{1} \hat{} {D}_{2} ) \& ONE & when {E}_{T} = - 2 \\ PAVG ( {D}_{1} , {D}_{2} ) - ONE & when {E}_{T} = - 1 \\ PAVG ( {D}_{1} , {D}_{2} ) - ( {D}_{1} \hat{} {D}_{2} ) \& ONE & when {E}_{T} = 0 \\ PAVG ( {D}_{1} , {D}_{2} ) & when {E}_{T} = 1\end{matrix} . \qquad ( 77 )$$

We simplify (77) as:
R=PAVG(D₁,D₂)−((ET₁ & ET₂)|E) & (ET₁|ET₂|E) & ONE−(D₁\hat{ }D₂) & ˜(ET₁\hat{ }ET₂\hat{ }E) & ONE. (78)
We can further simplify (78) as:
U₁=At least 1 ED,
U₂=At least 1 EC,
U₃=At least 1 EB,
U₄=Both EDs,
U₅=At least 2 ECs,
U₆=At least 3 ECs,
U₇=All 4 ECs,
U₈=At least 3 EBs,
U₉=At least 5 EBs,
U₁₀=At least 7 EBs,
U₁₁=At least 1 ED, EC or EB,
E₁=(EX & U₁₁)|(U₄ & (U₂|U₃))|(U₁ & U₆)|(U₁ & U₅ & U₃)|(U₁ & U₂ & U₈)|(U₁ & U₉)|(U₇ & U₃)|(U₆ & U₈)|(U₅ & U₉)|(U₂ & U₁₀),
E₂=(EX & U₄ & ((U₇ & U₃)|(U₆ & U₈)|(U₅ & U₉)|(U₂ & U₁₀))|(EX & U₁ & ((U₇ & U₉)|(U₆ & U₁₀)),
E=E₁+E₂. (79)

Clearly, (79) is an inefficient solution and is useful in special cases and for approximate solutions only.

iii. Approximate SIMD Solution

We have many approximate solutions by assuming the least significant bit of EB₁, . . . ,EB₈, EC₁, . . . EC₄, ED₁, or ED₂ as 0 or 1. With the assumption the last bit of E=ET₁=ET₂=1, we get from (78):
R=PAVG(D₁,D₂)−ONE. (80)
This solution requires 16 instructions, and produces a maximum error of ±1 in the final result for 8.6% of all possible values of A₁, . . . ,A₁₆ between [0,255]. The error never exceeds ±1. We receive a computational advantage of 67:16, and approximate 4 times speedup.
B. Type 4, Special Filter 1: R=(A₁+4A₂+6A₃+4A₄+A₅+8*ONE)>>4

This filter is a Gaussian approximation filter used for post-processing.

i. Conventional SIMD Solution

This filter can be implemented in SIMD architecture (assuming sufficient memory) by using the following steps:
1. (5 Instructions) A_{iL}=Unpack Low 4 Bytes of Aᵢ, for i∈{1,2,3,4,5},
2. (5 Instructions) A_{iH}=Unpack High 4 Bytes of Aᵢ, for i∈{1,2,3,4,5},
3. (9 Instructions) Add and Shift lower 4 words of A₁, . . . , A₅ to obtain lower 4 words of R_{L} as:
   R_{L}=(A_{1L}+4A_{2L}+6A_{3L}+4A_{4L}+A_{5L}+8*ONE₄)>>4,
4. (9 Instructions) Add and Shift higher 4 words of A₁, . . . , A₅ to obtain higher 4 words of R_{H} as:
   R_{H}=(A_{1H}+4A_{2H}+6A_{3H}+4A_{4H}+A_{5H}+8*ONE₄)>>4
5. (1 Instruction) Pack R_{H} and R_{L} into final register R.
   We require 29 instructions to compute this filter by conventional SIMD methods.
   ii. Efficient SIMD Solution
   From (73), we get the:
   B=PAVG(A₁,A₂), B₂=A₃, B₃=A₃, B₄=A₃, B₅=A₄, B₆\hat{ }A₄, B₇=A₅, B₈=A₅,
   C₁=PAVG(B₁,A₃), C₂=A₃, C₃=A₄, C₄=A₅,
   D₁=PAVG(C₁,A₃), D₂=PAVG(A₄,A₅),
   EB₁=A₁\hat{ }A₂, EB₂=EB₃=EB₄=EB₅=EB₆=EB₇=EB₈=0,
   EC₁=(B₁\hat{ }A₃), EC₂=EC₃=EC₄=0,
   ED₁=C₁\hat{ }A₃, ED₂=A₄\hat{ }A₅,
   E₁=EC₁ & EB₁, E₂=E₃=E₄=0,
   P₁=EC₁\hat{ }˜EB₁, P₀=EB₁, Q₁₌1, Q₀=0, ER₁=P₁,
   R₁=1, R₀=0, S₁=1, S₀=0, ER₂=1,
   U₂=ED₁|(E₁\hat{ }P₁, U₁=˜P₁, U₀=P₀,
   V₂=˜ED₂, V₁=0, V₀=0,
   E=U₂ & V₂,
   ET₁=(ED₁|(E₁\hat{ }ER₁)), ET₂=0. (81)
   From (78) we get:
   R=PAVG(D₁,D₂)−(˜E & ET₁ & ONE)−(D₁\hat{ }D₂) & (ET₁\hat{ }E) & ONE. (82)
   We can simplify (82) as follows:
   U=EC₁|EB₁,
   R=PAVG(D₁,D₂)−(((D₁\hat{ }D₂) & (ED₁|ED₂|U))|(ED₁ & ED₂ & U)) & ONE. (83)
   The solution in (83) requires 19 instructions with a 29:19 computational advantage.
   iii. Approximate SIMD Solution

We can assume the least significant bit of ED₁, ED₂, EC₁, or EB₁ as 0 or 1 to get several approximate solutions. We first make the assumption that the least significant bit of ED₁=1, and ED₂=EC₁=EB₁=0, to get the following solution:
R=PAVG(D₁,D₂)−(D₁\hat{ }D₂) & ONE. (84)
This solution requires 8 instructions, and produces a maximum error of ±1 for 12.5% of all possible values of A₁, . . . ,A₅ between [0,255]. The computational advantage is 29:8 (more than 3 times speedup).

The second approximate solution makes the assumption that the least significant bit of EC₁=1, and EB₁=0, to get the solution:
R=PAVG(D₁,D₂)−((D₁|D₂)|(ED₁ & ED₂)) & ONE. (85)
This solution requires 12 instructions, and produces a maximum error of ±1 for 6.25% of all possible values of A₁, . . . ,A₅ between [0,255]. The computational advantage is 29:12.
C. Type 4, Special Filter 2:

R=(A₁+A₂+2A₅+2A₆+2A₇+2Ag+4A₉+A+A₄+8*ONE)>>4

This filter is also a Gaussian approximation filter used for post-processing.

i. Conventional SIMD Solution

This filter can be implemented in SIMD architecture (assuming sufficient memory) by using the following steps:
1. (9 Instructions) A_{iL}=Unpack Low 4 Bytes of Aᵢ, for i∈{1,2, . . . ,9},
2. (9 Instructions) A_{iH}=Unpack High 4 Bytes of Aᵢ, for i∈{1,2, . . . ,9},
3. (15 Instructions) Add and Shift lower 4 words of A₁, . . . , A₅ to obtain lower 4 words of R_{L} as:
   R_{L}=(A_{1L}+A_{2L}+2A_{5L}+2A_{6L}+2A_{7L}+2A_{8L}+4A_{9L}+A_{3L}+A_{4L}+8*ONE₄)>>4,
4. (15 Instructions) Add and Shift higher 4 words of A₁, . . . , A₅ to obtain higher 4 words of R_{H} as:
   R_{H}=(A_{1H}+A_{2H}+2A_{5H}+2A_{6H}+2A_{7H}+2A_{8H}+4A_{9H}+A_{3A}+A_{4H}+8*ONE₄)>>4,
5. (1 Instruction) Pack R_{H} and R_{L} into final register R.
   We require 49 instructions to compute this filter by conventional SIMD methods.
   ii. Efficient SIMD Solution

From (73), we get the:
B=PAVG(A₁,A₂), B₂=PAVG(A₃,A₄), B₃=A₅, B₄=A₆, B₅=A₇, B₆=A₈, B₇=A₉, B₈=A₉,
C₁=PAVG(B₁,B₂), C₂=PAVG(A₅,A₆), C₃=PAVG(A₇,A₈), C₄=A₉,
D₁=PAVG(C₁,C₂), D₂=PAVG(C₃,A₉),
EB₁=(A₁\hat{ }A₂), EB₂=(A₃\hat{ }A₄), EB₃=EB₄=EB₅=EB₆=EB₇=EB₈=0,
EC₁=(B₁\hat{ }B₂), EC₂=(A₅\hat{ }A₆), EC₃=(A₇\hat{ }A₈), EC₄=0,
ED₁=(C₁\hat{ }C₂), ED₂=(C₃\hat{ }A₉),
E₁=EC₁ & (EB₁|EB₂), E₂=E₃=E₄=0,
P₁=EC₁\hat{ }(EB₁|EB₂), P₀=(EB₁\hat{ }EB₂), Q₁=˜EC₂, Q₀=0, ER₁=P₁ & Q₁,
R₁=˜EC₃, R₀=0, S₁=1, S₀=0, ER₂=R₁,
U₂=ED₁\hat{ }E₁\hat{ }(P₁ & Q₁), U₁=P₁\hat{ }Q₁, U₀=P₀,
V₂=ED₂\hat{ }R₁, V₁=˜R₁, V₀=0,
E=(U₂& V₂)|((U₂|V₂) & U₁ & V₁),
ET₁=(ED₁|(E₁\hat{ }ER₁)) & (E₁|˜ER₁), ET₂=(ED₂ & ˜ER₂) (86)

The final solution is same as (78). We can simplify this solution as follows:
U=EB₁|EB₂,
V=EC₁|EC₃,
W=EC₂|U|V,
Z=ED₁|ED₂,
F=Z|W,
H=EC₁ & EC₃,
G=(EC₂ & V)|H,
R=PAVG(D₁,D₂)−(((D₁\hat{ }D₂)&F)|(ED₁&ED₂&W)|(Z & ((EC₂&H)|(G&U)))) & ONE. (87)

The solution in (87) requires 36 instructions with a 49:36 computational advantage.

iii. Approximate SIMD Solution

We suggest 2 approximate solutions for this filter. For the first approximate solution, we assume the least significant bit of EC₃=0, and EB₁=EB₂=1 to get the following:
R=PAVG(D₁,D₂)−((D₁\hat{ }D₂)|(ED₁& ED₂)|((ED₁|ED₂) & EC₁ & EC₂)) & ONE. (88)
This solution requires 21 instructions, and produces a maximum error of ±1 for 6.25% of all possible values of A₁, . . . ,A₉ between [0,255]. The computational advantage is 49:21 (more than 2 times speedup).

The second approximate solution makes the assumption that the least significant bit of EB₁=EB₂=1. We get the solution:
U=(EC₁ & (EC₂|EC₃))|(EC₂ & EC₃),
R=PAVG(D₁,D₂)−((D₁\hat{ }D₂)|(ED₁&ED₂)|((ED₁|ED₂) & U)) & ONE. (89)
This solution requires 25 instructions, and produces a maximum error of ±1 for 3.12% of all possible values of A₁, . . . ,A₉ between [0,255]. The computational advantage is 49:25 (nearly 2 times speedup).
D. Type 4, Special Filter 3:

R=(A₁+2A₂+2A₂+2A₄+2A₅+2A₆+2A₇+2A₈+A₉+8*ONE)>>4

This filter is also used for post-processing.

i. Conventional SIMD Solution

This filter can be implemented in SIMD architecture (assuming sufficient memory) by using the following steps:
1. (9 Instructions) A_{iL}=Unpack Low 4 Bytes of Aᵢ, for i∈{1,2, . . . ,9},
2. (9 Instructions) A_{iH}=Unpack High 4 Bytes of Aᵢ, for i∈{1,2, . . . 9},
3. (17 Instructions) Add and Shift lower 4 words of A₁, . . . , A₅ to obtain lower 4 words of R_{L} as:
   R_{L}=(A_{1L}+2A_{2L}+2A_{3L}+2A_{4L}+2A_{5L}+2A_{6L}+2A_{7L}+2A_{8L}+A_{9L}+8*ONE₄)>>4,
4. (17 Instructions) Add and Shift higher 4 words of A₁, . . . , A₅ to obtain higher 4 words of R_{H} as:
   R_{H}=(A_{1H}+2A_{2H}+2A_{3H}+2A_{4H}+2A_{5H}+2A_{6H}+2A_{7H}+2A_{8H}+A_{9H}+8*ONE₄)>>4,
5. (1 Instruction) Pack R_{H} and R_{L} into final register R.
   We require 53 instructions to compute this filter by conventional SIMD methods.
   ii. Efficient SIMD Solution

From (73), we get the:
B₁=PAVG(A₁,A₂), B₂=A₂, B₃=A₃, B₄=A₄, B₅=A₅, B₆=A₆, B₇=A₇, B₈=A₈,
C₁=PAVG(B₁\hat{ }A₂), C₂=PAVG(A₃,A₄), C₃=PAVG(A₅,A₆), C₄=PAVG(A₇,A₈),
D₁=PAVG(C₁,C₂), D₂=PAVG(C₃,C₄),
EB₁=(A₁\hat{ }A₉), EB₂=EB₃=EB₄=EB₅=EB₆=EB₇=EB₈=0,
EC₁=(B₁\hat{ }A₂), EC₂=(A₃\hat{ }A₄), EC₃=(A₅\hat{ }A₆), EC₄=(A₇\hat{ }A₈),
ED₁=(C₁\hat{ }C₂), ED₂=(C₃\hat{ }C₄),
E₁=EC₁ & EB₁, E₂=E₃=E₄=0,
P₁=EC₁\hat{ }˜EB₁, P₀=EB₁, Q₁=˜EC₂, Q₀=0, ER₁=P₁ & Q₁,
R₁=˜EC₃, R₀=0, S₁=˜EC₄, S₀=0, ER₂=R₁ & S₁,
U₂=ED₁\hat{ }E₁\hat{ }(P₁ & Q₁), U₁=P₁\hat{ }Q₁, U₀=P₀,
V₂=ED₂\hat{ }(R₁ & S₁), V₁=R₁\hat{ }S₁, V₀=0,
E=(U₂ & V₂)|((U₂|V₂) & U₁ & V₁),
ET₁=(ED₁|(E₁\hat{ }ER₁)) & (E₁|˜ER₁), ET₂=(ED₂ & ˜ER₂). (90)
The final solution is same as (78). We can simplify this solution as follows:
U₁=EC₁ & EC₂,
U₂=EC₃ & EC₄,
U₃=ED₁ & ED₂,
V₁=EC₁|EC₂,
V₂=EC₃|EC₄,
V₃=ED₁|ED₂,
V₄=V₂|EB₁,
W=(V₁ & V₂ & EB₁)|(U₁ & V₄)|(U₂ & (V₁|EB₁)),
F=V₁|V₄,
E=D₁\hat{ }D₂,
G=U₁ & U₂& EB₁,
H=G & U₃ & E,
R=PAVG(D₁,D₂)−(((E & (V₃|F))|(U₃ & F)|(V₃ & W)|G) & ONE)−(H & ONE). (91)
The solution in (91) requires 46 instructions with a 53:46 computational advantage.
iii. Approximate SIMD Solution

We suggest 2 approximate solutions for this filter. For the first approximate solution, we assume the least significant bit of EC₁=EC₂=1, and EC₃=EC₄=0 to get the following:
R=PAVG(D₁,D₂)−((D₁\hat{ }D₂)|(ED₁ & ED₂)|((ED₁|ED₂) & EB₁)) & ONE. (92)
This solution requires 19 instructions, and produces a maximum error of ±1 for 9.38% of all possible values of A₁, . . . ,A₉ between [0,255]. The computational advantage is 53:19 (more than 3 times speedup).

The second approximate solution makes the assumption that the least significant bit of EC₁=1, and EC₃=0. We get the solution:
W=(EC₄ & EB₁)|(EC₂ & (EC₄|EB₁)),
R=PAVG(D₁,D₂)−((D₁\hat{ }D₂)|(ED₁ & ED₂)|((ED₁|ED₂) & W)) & ONE. (93)

This solution requires 25 instructions, and produces a maximum error of ±1 for 6.25% of all possible values of A₁, . . . , A₉ between [0,255]. The computational advantage is 53:25 (more than 2 times speedup).

E. Type 4, Special Filter 4: R=(A₁+2A₂+3A₃+4A₄+3A₅+2A₆+A₇+8*ONE)>>4

This filter is also used for post-processing.

i. Conventional SIMD Solution

This filter can be implemented in SIMD architecture (assuming sufficient memory) by using the following steps:
1. (7 Instructions) A_{iL}=Unpack Low 4 Bytes of Aᵢ, for i∈{1,2, . . . ,7},
2. (7 Instructions) A_{iH}=Unpack High 4 Bytes of Aᵢ, for i∈{1,2, . . . ,7},
3. (13 Instructions) Add and Shift lower 4 words of A₁, . . . , A₅ to obtain lower 4 words of R_{L} as:
   R_{L}=(A_{1L}+2A_{2L}+3A_{3L}+4A_{4L}+3A_{5L}+2A_{6L}+A_{7L}+8*ONE₄)>>4,
4. (13 Instructions) Add and Shift higher 4 words of A₁, . . . , A₅ to obtain higher 4 words of R_{H} as:
   R_{H}=(A_{1H}+2A_{2H}+3A_{3H}+4A_{4H}+3A_{5H}+2A_{6H}+A_{7H}+8*ONE₄)>>4,
5. (1 Instruction) Pack R_{H} and R_{L} into final register R.
   We require 41 instructions to compute this filter by conventional SIMD methods.
   ii. Efficient SIMD Solution

From (73), we get the:
B₁=PAVG(A₁,A₇), B₂=A₂, B₃=A₄, B₄=A₄, B₅=A₃, B₆=A₅, B₇=A₆, B₈=PAVG(A₃,A₅),
C₁=PAVG(B₁,A₂), C₂=A₄, C₃=PAVG(A₃,A₅), C₄=PAVG(A₆,B₈),
D₁=PAVG(C₁,A₄), D₂=PAVG(C₃,C₄),
EB₁=A₁\hat{ }A₇, EB₂=EB₃=EB₄=EB₅=EB₆=EB₇=0, EB₈=A₃\hat{ }A₅,
EC₁=B₁\hat{ }A₂, EC₂=0, EC₃=A₃\hat{ }A₅, EC₄=A₆\hat{ }B₈,
ED₁=C₁\hat{ }A₄, ED₂=C₃\hat{ }C₄,
E₁=EC₁ & EB₁, E₂=E₃=0, E₄=EC₄ & EB₈,
P₁=EC₁\hat{ }˜EB₁, P₀=EB₁, Q₁=1, Q₀=0, ER₁=P₁,
R₁=˜EC₃, R₀=0, S₁=EC₄\hat{ }˜EB₈, S₀=EB₈, ER₂=R₁ & S₁,
U₂=ED₁\hat{ }E₁\hat{ }P₁, U₁=˜P₁, U₀=P₀,
V₂=ED₂\hat{ }E₄\hat{ }(R₁ & S₁), V₁=R₁\hat{ }S₁, V₀=S₀,
E=(U₂ & V₂)|((U₂|V₂) & U₁ & V₁)|((U₂|V₂) & (U₁|V₁) & U₀ & V₀),
ET₁=(ED₁|(E₁\hat{ }P₁)) & (E₁|˜P₁), ET₂=(ED₂|(E₄\hat{ }ER₂)) & (E₄|˜ER₂) (94)
The final solution is same as (78). We can simplify this solution as follows:
U₁=EC₃|EC₄,
U₂=EB₁|EB₈,
U₃=ED₁|ED₂,
U₄=EC₁|U₁,
U₅=U₄|U₂,
U₆=U₅|U₃,
U₇=EC₃ & EC₄,
U₈=(EC₁ & U₁)|U₇,
U₉=(EC₁ & U₇)|(U₈ & U₂),
R=PAVG(D₁,D₂)−(((D₁\hat{ }D₂) & U₆)|(ED₁ & ED₂ & U₅)|(U₃ & U₉)) & ONE. (95)
The solution in (95) requires 36 instructions with a 41:36 computational advantage.
iii. Approximate SIMD Solution

We suggest 2 approximate solutions for this filter. For the first approximate solution, we assume the least significant bit of EC₁=EC₃=1, and EC₄=EB₁=0 to get the following:
R=PAVG(D₁,D₂)−((D₁\hat{ }D₂)|(ED₁ & ED₂)|((ED₁|ED₂) & EB₈)) & ONE. (96)
This solution requires 19 instructions, and produces a maximum error of ±1 for 6.25% of all possible values of A₁, . . . ,A₇ between [0,255]. The computational advantage is 41:19 (more than 2 times speedup).

The second approximate solution makes the assumption that the least significant bit of EC₃=1, and EB₁=0. We get the solution:
U₉=(EC₁ & EC₄)|((EC₁|EC₄) & EB₈),
R=PAVG(D₁,D₂)−((D₁\hat{ }D₂)|(ED₁ & ED₂)|((ED₁|ED₂) & U₉)) & ONE. (97)
This solution requires 25 instructions, and produces a maximum error of ±1 for 3.13% of all possible values of A₁, . . . ,A₇ between [0,255]. The computational advantage is 41:25.
F. Type 4, Summary of Results

Table VI below summarizes the instructions required to compute each filter (given sufficient memory) by the efficient and conventional SIMD methods. For the Efficient case, we give the instructions required for the exact and approximate solutions.

### Summary of Results for Type 4 FIR Filters

TABLE VI

| | | Efficient | | | |
|---|---|---|---|---|---|
| | Conventional | Method | | Speedup | |
| Type 4 Filters | Method | Exact | Approx. | Exact | Approx. |
| (A₁ + A₂ + . . . + A₁₆ + | 67 | N/A | 16 | N/A | 4.2 |
| 8 * ONE) >> 4 | | | | | |
| (A₁ + 4A₂ + 6A₃ + 4A₄ + | 29 | 19 | 8 | 1.5 | 3.6 |
| A₅ + 8 * ONE) >> 4 | | | | | |
| (A₁ + A₂ + 2A₅ + 2A₆ + | 49 | 36 | 21 | 1.4 | 2.3 |
| 2A₇ + 2A₈ + 4A₉ + A₃ + | | | | | |
| A₄ + 8 * ONE) >> 4 | | | | | |
| (A₁ + 2A₂ + 2A₃ + 2A₄ + | 53 | 46 | 19 | 1.2 | 2.8 |
| 2A₅ + 2A₆ + 2A₇ + 2A₈ + | | | | | |
| A₉ + 8 * ONE) >> 4 | | | | | |
| (A₁ + 2A₂ + 3A₃ + 4A₄ + | 41 | 36 | 19 | 1.1 | 2.2 |
| 3A₅ + 2A₆ + A₇ + | | | | | |
| 8 * ONE) >> 4 | | | | | |

The shaded areas show significant improvements in efficiency due to the analyses developed here.

5. Corrected Approximation Method

Another approach, referred to as the “corrected approximation” method, can be used to improve upon the approaches described in sections 3 and 4 when exact computation is required. Steps of the corrected approximation method include the following:
1. Use PAVG to quickly get an approximation to the correct result.
2. Adjust the approximation so that it becomes no less than the correct result.
3. Perform another computation to determine the value of the least significant bits of the correct result.
4. Use the value of the least significant bits from step 3 to determine the error of the value obtained from step 2.
5. Subtract the error value in step 4 from the approximate value in step 2 in order to get the correct final result.

Examples of the corrected approximation method are given in the following subsections for type 3 and type 4 filters, respectively.

A. Corrected Approximation Method Applied to Type 3 Filters

As in section 3, we define the following packed 64-bit registers, each containing 8 data elements of one byte each:
B₁=PAVG(A₁,A₂), B₂=PAVG(A₃,A₄), B₃=PAVG(A₅,A₆), B₄=PAVG(A₇,A₈),
C₁=PAVG(B₁,B₂), C₂=PAVG(B₃,B₄), D=PAVG(C₁,C₂). (98)
D is computed in 7 operations, and is an approximate solution to all filters of the form:
R=(A₁+A₂+A₃+A₄+A₅+A₆+A₇+A₈+c*ONE)>>3,where 0≦c≦4

It can be determined how far off D can be from the correct value of R. The proof is omitted for the purpose of brevity, but the answer is R−1≦D≦R+2.

After D is computed, the second step is to increase D by 1, so that D is at least as big as R. However, one must be cautious on this step: if a byte holds the value of 255 and it is increased by 1, then most architectures automatically clip the sum of 256 so that it becomes 0, which is not what we want. This is remedied by using a “saturated add”, which will add 1 to each packed byte only if that byte is less than 255. All bytes that are 255 remain the same. The instruction for this is PADDUSB:
PADDUSB(D, 1) (99)
Thus, after 8 instructions, we have computed a value D satisfying R≦D≦R+3.

The third step is to determine the correct least significant bits of R. This is done by performing the computation of R as it is defined:
L=CLIP(A₁+A₂+A₃+A₄+A₅+A₆+A₇+A₈+c*ONE)>>3 (100)
The value c*ONE is a stored constant similar to ONE, so there is no need to perform a multiply. Also, most architecture perform the CLIP automatically, so this does not count as an extra instruction. In total there are 8 adds and 1 shift to compute L, which holds the 5 least significant bits of R for each packed byte.

The fourth step uses L to determine the error term for D. Since we know that D is at most 3 more than R, we only need to figure out how much needs to be subtracted from D so that it agrees with L in the two least significant bits. This is accomplished by:
E=CLIP(D−L) & THREE (101)
As before, the CLIP comes for free on most architectures and THREE is a stored constant similar to ONE. In 2 instructions, the error term has been determined. The final step is to subtract this error from D to get the final result. This is 1 additional instruction.
R=D−E (102)

In total this is 20 instructions, or 19 when c=0 since an addition can be saved. Pseudo-code for the approach using 20 instructions is shown in Table VII, below.

TABLE VII

#define P(a,b) (((a) + (b) + 1) >> 1)
b1 = P(a01,a02);
b2 = P(a03,a04);
b3 = P(a05,a06);
b4 = P(a07,a08);
c1 = P(b1,b2);
c2 = P(b3,b4);
d = P(c1,c2);
d = ((int)d + 1) < 256 ? d + 1:255; /* saturated add */
e = (a01 + a02 + a03 + a04 + a05 + a06 + a07 + a08 + cc) >> 3;
dd = (d − e) & 0x03;
x1 = d − dd;

The approach of Table VII provides an exact answer in 20 instructions compared to 32 of the approach of Table III. In fact, the exact solution provided by Table VII even beats the approximate solution of Table VI (22 instructions). However, the approximate solution offers significant advantages in many special filter computations.

Further refinements can be obtained when certain operands are repeated. For instance, consider the following filter:
(A₁+A₂+2A₃+2A₅+2A₇+4*ONE)>>3

There is no need to do PAVG(A₃,A₃),PAVG(A₅,A₅), or PAVG(A₇,A₇) since any PAVG of a number with itself is just itself. This saves 3 instructions. Further, the computation of L can be shortened by first doing (A₃+A₅+A₇)<<1 and then adding on the remaining parts. Hence there are only 5 additions, but 1 additional shift instruction. The net savings on L is 2 instructions, and the total net savings is 5 instructions.

Our results are summarized in Table VIII below.

### Summary of Results for Type 3 FIR Filters

TABLE VIII

| | | Corrected |
|---|---|---|
| | | Approximation |
| Type 3 Filters | Section 3 Method | Method |
| (A₁ + A₂ + . . . + A₈ + | 32 | 20 |
| 4 * ONE) >> 3 | | |
| (A₁ + A₂ + . . . + A₈ + | 35 | 20 |
| 3 * ONE) >> 3 | | |
| (A₁ + A₂ + . . . + A₈ + | 34 | 20 |
| 2 * ONE) >> 3 | | |
| (A₁ + A₂ + . . . + A₈ + | 35 | 20 |
| 1 * ONE) >> 3 | | |
| (A₁ + A₂ + . . . + A₈) >> 3 | 34 | 19 |
| (A₁ + 2A₃ + 2A₅ + 2A₇ + A₂ + | 16 | 15 |
| 4 * ONE) >> 3 | | |
| (A₁ + A₂ + A₃ + 3A₄ + 2A₇ + | 19 | 17 |
| 4 * ONE) >> 3 | | |
| (A₁ + A₂ + A₃ + 2A₄ + A₅ + A₆ + | 27 | 19 |
| A₇ + 4 * ONE) >> 3 | | |

B. Corrected Approximation Method Applied to Type 4 Filters

Following section 4, we define the following packed 64-bit registers, each containing 8 data elements of one byte each:
B₁=PAVG(A₁,A₂), B₂=PAVG(A₃,A₄), B₃=PAVG(A₅,A₆), B₄=PAVG(A₇,A₈),
B₅=PAVG(A₉,A₁₀), B₆=PAVG(A₁₁,A₁₂), B₇=PAVG(A₁₃,A₁₄), B₈=PAVG(A₁₅,A₁₆),
C₁=PAVG(B₁,B₂), C₂=PAVG(B₃,B₄), C₃=PAVG(B₅,B₆), C₄=PAVG(B₇,B₈),
D₁=PAVG(C₁,C₂), D₂=PAVG(C₃,C₄), D=PAVG(D₁,D₂) (103)
D is computed in 15 operations, and is an approximate solution to all filters of the form:
R=(A₁+A₂+A₃+A₄+A₅+A₆+A₇+A₈+A₉+A₁₀+A₁₁+A₁₂+A₁₃+A₁₄+A₁₅+A₁₆+c*ONE)>>3
where 0≦c≦8. It can be shown that R−1≦D≦R+2.

The remaining steps are more or less the same as done for the type 3 filters:
PADDUSB(D, 1)
L=CLIP(A₁+A₂+A₃+A₄+A₅+A₆+A₇+A₈+A₉+A₁₀+A₁₁+A₁₂+A₁₃+A₁₄+A₁₅+A₁₆+c*ONE)>>3
E=CLIP(D−L) & THREE
R=D−E (104)

In total this is 36 instructions, or 35 when c=0 since an addition can be saved. The results are summarized in Table IX below.

### Summary of Results for Type 4 FIR Filters

TABLE IX

| | | Corrected |
|---|---|---|
| | Section 5 | Approximation |
| Type 4 Filters | Method | Method |
| (A₁ + A₂ + . . . + A₁₆ + 8 * ONE) >> 4 | N/A | 36 |
| (A₁ + 4A₂ + 6A₃ + 4A₄ + A₅ + | 19 | 18 |
| 8 * ONE) >> 4 | | |
| (A₁ + A₂ + 2A₅ + 2A₆ + 2A₇ + 2A₈ + | 36 | 24 |
| 4A₉ + A₃ + A₄ + 8 * ONE) >> 4 | | |
| (A₁ + 2A₂ + 2A₃ + 2A₄ + 2A₅ + 2A₆ + | 46 | 22 |
| 2A₇ + 2A₈ + A₉ + 8 * ONE) >> 4 | | |
| (A₁ + 2A₂ + 3A₃ + 4A₄ + 3A₅ + 2A₆ + | 36 | 24 |
| A₇ + 8 * ONE) >> 4 | | |

Although the invention has been discussed with respect to specific embodiments thereof, these embodiments are merely illustrative, and not restrictive, of the invention. For example, although a two-operand SIMD instruction has been primarily discussed, techniques and features of the invention may be applicable to other applications where the number of operands, or arguments, of a SIMD instruction are not the same as the number of variables, or values, in a formula, computation or function to be implemented with the SIMD instruction (i.e., a “mismatched” instruction).

Although the invention has been described with respect to specific SIMD instructions to obtain an average of values, any other type of SIMD instruction or operation may benefit from the approach of the invention. Although specific operations such as addition, subtraction, bitwise AND, bitwise OR, bitwise logical right shift, bitwise logical left shift, bitwise exclusive OR, etc., are used in specific embodiments to achieve a result, other embodiments may use different operations, or combinations of operations, to achieve results. For example, an AND function can be realized by using an OR function and complementing, or inverting, the operands and result. Other such operational equivalents will be apparent.

Alternative methods of detecting when the sum of two packed values results in an odd number can be employed. Some processors may provide instructions that combine multiple operations into compound one or more instructions. Although specific reference has been made to a “SIMD” type of instruction, other types of parallel instructions may be within the scope of the invention. Although the SIMD instruction has been described as a single instruction, other embodiments may use SIMD instructions that occupy more than a single instruction's worth of clock cycles, instruction cycles, or the like.

There are various ways that the invention can be modified from specific embodiments described herein to achieve similar results. For example, adjustments to an approximate solution are performed as an intermediate step before computing the final result so that the approximate solution is no less than the actual solution. One modification can be to adjust the approximate solution so that it becomes no larger than the actual solution as an intermediate step. Such modifications will be apparent to one of skill in the art and are within the scope of the invention.

Any suitable programming language can be used to implement the routines of the present invention including C, C++, Java, assembly language, etc. Different programming techniques can be employed such as procedural or object oriented. The routines can execute on a single processing device or multiple processors. Although the steps, operations or computations may be presented in a specific order, this order may be changed in different embodiments. In some embodiments, multiple steps shown as sequential in this specification can be performed at the same time. The sequence of operations described herein can be interrupted, suspended, or otherwise controlled by another process, such as an operating system, kernel, etc. The routines can operate in an operating system environment or as stand-alone routines occupying all, or a substantial part, of the system processing.

Steps can be performed in hardware or software, as desired. Note that steps can be added to, taken from or modified from the steps presented in this specification without deviating from the scope of the invention. In general, the flowcharts are only used to indicate one possible sequence of basic operations to achieve a functional aspect of the present invention.

In the description herein, numerous specific details are provided, such as examples of components and/or methods, to provide a thorough understanding of embodiments of the present invention. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

A “computer-readable medium” for purposes of embodiments of the present invention may be any medium that can contain, store, communicate, propagate, or transport the program for use by or in connection with the instruction execution system, apparatus, system or device. The computer readable medium can be, by way of example only but not by limitation, an electronic, magnetic, optical, electromagnetic, infrared, or semiconductor system, apparatus, system, device, propagation medium, or computer memory.

A “processor” includes any system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real time,” “offline,” in a “batch mode,” etc. Portions of processing can be performed at different times and at different locations, by different (or the same) processing systems.

Reference throughout this specification to “one embodiment”, “an embodiment”, or “a specific embodiment” means that a particular feature, structure, or characteristic described in connection with the embodiment is included in at least one embodiment of the present invention and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

Embodiments of the invention may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of the present invention can be achieved by any means as is known in the art. Distributed, or networked, systems components and circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope of the present invention to implement a program or code that can be stored in a machine-readable medium to permit a computer to perform any of the methods described above.

Additionally, any signal arrows in the drawings/Figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims.

1. A method for achieving an averaged result on packed binary values for use in finite impulse response filter computations, the method using an averaging instruction that computes an average on first and second sets of packed values to produce a resulting set of packed averages, the method comprising
successively applying the averaging instruction to packed values to produce a result, D, that is an approximate desired result;
adjusting D to be in a predetermined relation to a desired exact result; and
using D in a finite impulse response operation.

2. The method of claim 1, wherein the predetermined relation to a desired exact result includes ensuring that D is no more than the desired exact result.

3. The method of claim 1, wherein the predetermined relation to a desired exact result includes ensuring that D is no less than the desired exact result.

4. The method of claim 1, wherein the predetermined relation to a desired exact result includes ensuring that D is within a predetermined threshold of the desired exact result.

5. The method of claim 1, wherein the step of adjusting D includes a substep of adding a constant value to D.

6. The method of claim 5, wherein the constant value includes 1.

7. The method of claim 6, wherein the substep of adding the constant value to D further comprises
using a saturated add.

8. The method of claim 7, further comprising
determining a correct least significant bits of a desired exact result.

9. The method of claim 7, further comprising
determining an error amount for D; and
adjusting D in accordance with the error amount.

10. The method of claim 1, wherein the step of adjusting D includes a substep of
subtracting a constant value from D.

11. The method of claim 10, wherein the constant value includes 2.

12. The method of claim 10 wherein the substep of subtracting the constant value from D further comprises
using a saturated subtract.

13. The method of claim 10, further comprising
determining a correct least significant bits of a desired exact result.

14. The method of claim 10, further comprising
determining an error amount for D; and
adjusting D in accordance with the error amount.

15. The method of claim 1, wherein the averaging instruction includes a PAVG instruction.

16. The method of claim 15, further comprising
detecting when a PAVG operation would be applied to two same operands and, if so performing the step of omitting application of the PAVG operation and using one of the same operands values as the result of the PAVG operation.

17. The method of claim 1, wherein D is adjusted to be an exact desired result.

18. A method for using a single-instruction multiple-data (SIMD) instruction to perform a function, wherein the SIMD instruction uses M arguments, wherein the function uses N variables, wherein M and N are not the same, the method comprising
using the SIMD instruction on a plurality of packed values to obtain an approximate packed value result;
adjusting the approximate packed value result to obtain an adjusted packed value result, wherein the adjusted packed value result is in a predetermined relation to a desired exact result; and
using the adjusted packed value result in an FIR calculation.

19. The method of claim 18, wherein the SIMD instruction includes an averaging operation

20. The method of claim 19, wherein the step of using the SIMD instruction includes
using a PAVG instruction.

21. The method of claim 18, wherein the predetermined relation to a desired exact result includes ensuring that the adjusted packed value result is no more than the desired exact result.

22. The method of claim 18, wherein the predetermined relation to a desired exact result includes ensuring that the adjusted packed value result is no less than the desired exact result.

23. The method of claim 18, wherein the predetermined relation to a desired exact result includes ensuring that the adjusted packed value result is within a predetermined threshold of the desired exact result.

24. The method of claim 18, wherein the predetermined relation to a desired exact result includes adjusting the adjusted packed value result to be closer to the desired exact result.

25. The method of claim 18, wherein the step of adjusting the approximate packed value result includes a substep of
adding the value 1 to the approximate packed value result.

26. The method of claim 25, wherein the substep of adding the value 1 further comprises
using a saturated add.

27. The method of claim 18, wherein the step of adjusting the approximate packed value result includes a substep of
subtracting the value 2 from the approximate packed value result.

28. The method of claim 18, further comprising
determining a correct least significant bits of a desired exact result.

29. The method of claim 18, further comprising
determining an error amount for the approximate packed value result; and
adjusting the approximate packed value result in accordance with the error amount.

30. The method of claim 20, further comprising
detecting when a PAVG operation would be applied to two same operands and, if so performing the step of omitting application of the PAVG operation and using one of the same operands values as the result of the PAVG operation.

31. A computer-readable medium including instructions for using a single-instruction multiple-data (SIMD) instruction to perform a function, wherein the SIMD instruction uses M arguments, wherein the function uses N variables, wherein M and N are not the same, the computer-readable medium comprising
one or more instructions for using the SIMD instruction on a plurality of packed values to obtain an approximate packed value result;
one or more instructions for adjusting the approximate packed value result to obtain an adjusted packed value result, wherein the adjusted packed value result is in a predetermined relation to a desired exact result; and
one or more instructions for using the adjusted packed value result in an FIR calculation.

32. An apparatus for using a single-instruction multiple-data (SIMD) instruction to perform a function, wherein the SIMD instruction uses M arguments, wherein the function uses N variables, wherein M and N are not the same, the apparatus comprising
a processor coupled to a storage device;
one or more instructions stored in the storage device for using the SIMD instruction on a plurality of packed values to obtain an approximate packed value result;
one or more instructions stored in the storage device for adjusting the approximate packed value result to obtain an adjusted packed value result, wherein the adjusted packed value result is in a predetermined relation to a desired exact result; and
one or more instructions stored in the storage device for using the adjusted packed value result in an FIR calculation.
